(19) United States
(12) Patent Application Publication
(10) Pub. No.: US 2025/0126666 A1
(43) Pub. Date: Apr. 17, 2025

(54) HUB DEVICE AND CONTROLLING METHOD THEREOF

(71) Applicant: SAMSUNG ELECTRONICS CO., LTD., Suwon-si (KR)

(72) Inventors: Jeongsoo LEE, Suwon-si (KR); Ilyong PARK, Suwon-si (KR); Soosin HWANG, Suwon-si (KR); Jaehwan SIM, Suwon-si (KR); Jongjik LEE, Suwon-si (KR)

(73) Assignee: SAMSUNG ELECTRONICS CO., LTD., Suwon-si (KR)

(21) Appl. No.: 18/975,178

(22) Filed: Dec. 10, 2024

Related U.S. Application Data
(63) Continuation of application No. PCT/KR2024/011815, filed on Aug. 8, 2024.

(30) Foreign Application Priority Data
Oct. 17, 2023 (KR) 10-2023-0138547

(51) Int. Cl. H04W 76/15; H04W 4/80

(52) U.S. Cl. CPC H04W 76/15; H04W 4/80

(57) ABSTRACT

A first hub device is provided. The first hub device includes: a communication interface; at least one processor; and a memory storing instructions that, when executed by the at least one processor, cause the first hub device to: broadcast, through the communication interface, a connection request to search for a device configured to connect to a server, based on a predetermined event being identified; and transmit, through the communication interface, a candidate list indicating the first hub device and a second hub device to the second hub device based on a response corresponding to the connection request being received from the second hub device.

### CROSS-REFERENCE TO RELATED APPLICATION

This application is a bypass continuation of International Application No. PCT/KR2024/011815, filed on Aug. 8, 2024, which is based on and claims priority to Korean Patent Application No. 10-2023-0138547, filed on Oct. 17, 2023, in the Korean Intellectual Property Office, the disclosures of which are incorporated by reference herein in their entireties.

### BACKGROUND

### 1. Field

The present disclosure relates to a hub device and a control method thereof, and more particularly, to a hub device that is connected to an Internet of Things (IoT) network and controls at least one device and a control method thereof.

### 2. Description of Related Art

A plurality of Internet of Things (IoT) devices used by users may be managed through an IoT network. The IoT network may be connected to an external server. A hub device may connect the IoT network to the external server. The hub device may perform a hub function that connects the external server and the IoT device.

Because it may be difficult for IoT devices to connect directly to the external server, the IoT device and the external server may be connected through the hub device. When controlling the IoT device through the hub device, the hub device needs to be registered on the external server.

When a plurality of hub devices exist in the IoT network, the process of registering the plurality of hub devices on the external server may be difficult. It may be difficult for a user to recognize which of the plurality of hub devices needs to be registered.

In addition, when there are the plurality of hub devices and the user requests the registration process in the server 200 multiple times, there may be confusion in configuring the IoT network or the inefficiency in data flow may increase.

### SUMMARY

The disclosure relates to a hub device that generates a candidate list to automatically manage a plurality of hub devices and shares the candidate list with a plurality of sub devices, and a control method thereof.

In accordance with an aspect of the disclosure, a first hub device, includes: a communication interface; at least one processor; and a memory storing instructions that, when executed by the at least one processor, cause the first hub device to: broadcast, through the communication interface, a connection request to search for a device configured to connect to a server, based on a predetermined event being identified; and transmit, through the communication interface, a candidate list indicating the first hub device and a second hub device to the second hub device based on a response corresponding to the connection request being received from the second hub device.

The communication interface may include a first communication module (or first communication interface) and a second communication module (or second communication interface). The instructions, when executed by the at least one processor, may cause the first hub device to: connect to the server through the first communication module; and connect to the second hub device through the second communication module.

The instructions, when executed by the at least one processor, may cause the first hub device to acquire the candidate list indicating the first hub device and the second hub device based on the response being received through Bluetooth low energy (BLE) communication.

The instructions, when executed by the at least one processor, may cause the first hub device to acquire the candidate list including identification information indicating the second hub device based on the response.

The connection request may be a first connection request, the response may be a first connection response, the candidate list may be a first candidate list, and the instructions, when executed by the at least one processor, may cause the first hub device to: broadcast, through the communication interface, a second connection request based on a third hub device being identified; acquire a second candidate list indicating the first hub device, the second hub device, and the third hub device based on a second response corresponding to the second connection request being received from the third hub device; update the first candidate list to the second candidate list; and transmit the second candidate list to the second hub device and the third hub device through the communication interface.

The instructions, when executed by the at least one processor, may cause the first hub device to: broadcast, through the communication interface, a third connection request based on the third hub device not being detected; acquire a third candidate list indicating the first hub device and the second hub device based on a response corresponding to the third connection request not being received from the third hub device within a predetermined time; update the second candidate list to the third candidate list; and transmit the third candidate list to the second hub device through the communication interface.

The instructions, when executed by the at least one processor, may cause the first hub device to: transmit an activation request to the second hub device through the communication interface based on a first user input for registration being received; generate a connection list indicating the first hub device and the second hub device based on an activation response corresponding to the activation request being received from the second hub device; and transmit the connection list to the server through the communication interface.

The instructions, when executed by the at least one processor, may cause the first hub device to: receive, through the communication interface, a control command from the server related to an end device connected to the second hub device; and transmit the control command to the second hub device through the communication interface.

The instructions, when executed by the at least one processor, may cause the first hub device to transmit control information to the server through the communication interface when a control command related to an end device connected to the second hub device is received from the second hub device.

The first hub device may further include a display. The instructions, when executed by the at least one processor, may cause the first hub device to: control the display to output a guide screen including the connection list; and transmit a registration request for the first hub device to the server through the communication interface based on a second user input corresponding to the registration of the first hub device being received through the guide screen.

In accordance with an aspect of the disclosure, a control method of a first hub device includes: broadcasting a connection request to search for a device configured to connect to a server based on a predetermined event being identified; and transmitting a candidate list indicating the first hub device and a second hub device to the second hub device based on a response corresponding to the connection request being received from the second hub device.

The first hub device may include a first communication module and a second communication module. The first hub device may be connected to the server through the first communication module, and the first hub device may be connected to the second hub device through the second communication module.

The control method may further include acquiring the candidate list indicating the first hub device and the second hub device based on the response being received through Bluetooth low energy (BLE) communication.

The control method may further include acquiring the candidate list including identification information indicating the second hub device based on the response.

The connection request may be a first connection request, the response may be a first connection response, the candidate list may be a first candidate list, and the control method may further include: broadcasting a second connection request based on a third hub device being identified; acquiring a second candidate list indicating the first hub device, the second hub device, and the third hub device based on a second response corresponding to the second connection request being received from the third hub device; updating the first candidate list to the second candidate list; and transmitting the second candidate list to the second hub device and the third hub device.

In accordance with an aspect of the disclosure, a non-transitory computer-readable medium stores computer instructions for a hub device to perform an operation, the operation including: broadcasting a connection request to search for a device configured to connect to a server based on a predetermined event being identified; and transmitting a candidate list indicating the hub device and a second hub device to the second hub device based on a response corresponding to the connection request being received from the second hub device.

The hub device may include a first communication module and a second communication module, wherein the hub device may be connected to the server through the first communication module, and the hub device may be connected to the second hub device through the second communication module.

The operation may further include acquiring the candidate list indicating the hub device and the second hub device based on the response being received through Bluetooth low energy (BLE) communication.

The operation may further include acquiring the candidate list including identification information indicating the second hub device based on the response.

The connection request may be a first connection request, the response may be a first connection response, the candidate list may be a first candidate list, and the operation may further include: broadcasting a second connection request based on a third hub device being identified; acquiring a second candidate list indicating the hub device, the second hub device, and the third hub device based on a second response corresponding to the second connection request being received from the third hub device; updating the first candidate list to the second candidate list; and transmitting the second candidate list to the second hub device and the third hub device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing an access point (AP) network according to an embodiment;

FIG. 2 is a block diagram illustrating a hub device according to an embodiment;

FIG. 3 is a block diagram for describing a detailed configuration of the hub device of FIG. 2 according to an embodiment;

FIG. 4 is a diagram for describing an operation of generating a candidate list according to an embodiment;

FIG. 5 is a diagram illustrating an operation of generating a candidate list by confirming a predetermined communication method, according to an embodiment;

FIG. 6 is a diagram for describing a screen related to a registration operation, according to an embodiment;

FIG. 7 is a diagram for describing an operation of updating a candidate list, according to an embodiment;

FIG. 8 is a diagram for describing an operation of updating a candidate list, according to an embodiment;

FIG. 9 is a diagram for describing an operation of updating a candidate list, according to an embodiment;

FIG. 10 is a diagram for describing a screen for a search function of a hub device, according to an embodiment;

FIG. 11 is a diagram for describing a screen related to detection of a new hub device according to an embodiment;

FIG. 12 is a diagram for describing a screen related to detection of a new hub device according to an embodiment;

FIG. 13 is a diagram for describing a screen related to detection of a new end device according to an embodiment;

FIG. 14 is a diagram for describing an operation of registering a hub device on a server according to an embodiment;

FIG. 15 is a diagram for describing an operation of registering a hub device on a server according to an embodiment;

FIG. 16 is a diagram for describing an operation of transmitting a control command to an end device according to an embodiment;

FIG. 17 is a diagram for describing an operation of transmitting a control command to an end device according to an embodiment;

FIG. 18 is a diagram for describing an operation of transmitting a control command to an end device according to an embodiment;

FIG. 19 is a diagram for describing a screen for selecting a registered device according to an embodiment;

FIG. 20 is a diagram for describing a screen for selecting a registered device according to an embodiment;

FIG. 21 is a diagram for describing an operation of updating a candidate list, according to an embodiment;

FIG. 22 is a diagram for describing a screen indicating a plurality of accounts according to an embodiment; and

FIG. 23 is a diagram for describing a control method of a hub device, according to an embodiment.

### DETAILED DESCRIPTION

Embodiments are described below with reference to the accompanying drawings. Embodiments described herein are examples, and thus, the present disclosure is not limited thereto, and may be realized in various other forms. Each embodiment provided in the following description is not excluded from being associated with one or more features of another example or another embodiment also provided herein or not provided herein but consistent with the present disclosure.

General terms that are currently widely used were selected as terms used in embodiments of the present disclosure in consideration of functions in the present disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the present disclosure. Therefore, the terms used in the present disclosure should be defined on the basis of the meaning of the terms and the contents throughout the present disclosure rather than simple names of the terms.

In the disclosure, expressions such as “have”, “may have”, “include”, “may include”, or the like, indicate existence of a corresponding feature (for example, a numerical value, a function, an operation, a component such as a part, or the like), and does do exclude existence of an additional feature.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Expressions such as “first,” “second,” “1st” or “2nd” or the like, used in the present disclosure may indicate various components regardless of a sequence and/or importance of the components, will be used only in order to distinguish one component from the other components, and do not limit the corresponding components.

When a component (for example, a first component) is described as coupled with or connected to another component (for example, a second component), it is to be understood that the component may be directly coupled to another component or may be coupled to the other component through an additional component (for example, a third component).

Singular forms are intended to include plural forms unless the context clearly indicates otherwise. It will be further understood that terms “include” or “formed of”' used in the present specification specify the presence of features, numerals, steps, operations, components, parts, or combinations thereof mentioned in the present specification, but do not preclude the presence or addition of one or more other features, numerals, steps, operations, components, parts, or combinations thereof.

In the disclosure, a “module” or a “˜er/or” may perform at least one function or operation, and be implemented by hardware or by hardware controlled by software. In addition, a plurality of “modules” or a plurality of “˜ers/˜ors” may be integrated in at least one module and be implemented by at least one processor except for a “module” or a “˜er/or” that needs to be implemented by specific hardware. Operations may be processed by “one processor” or “a combination of processors.” For example, Processor 1 may perform functions A and B, and Processor 2 may perform function C, or Processor 1 may perform part of function A while Processor 2 performs the remainder of function A, as well as functions and B and C.

The term “user” may refer to a person using an electronic device or a device (for example, an artificial intelligence electronic device) using an electronic device.

Hereinafter, embodiments will be described in detail with reference to the accompanying drawings.

A hub device, an end device, etc., may be described as electronic devices. The first hub device, the second hub device, and the third hub device may be described as a first electronic device, a second electronic device, a third electronic device, etc. The first hub device, the second hub device, and the third hub device may be described as hub devices without ordinal numbers.

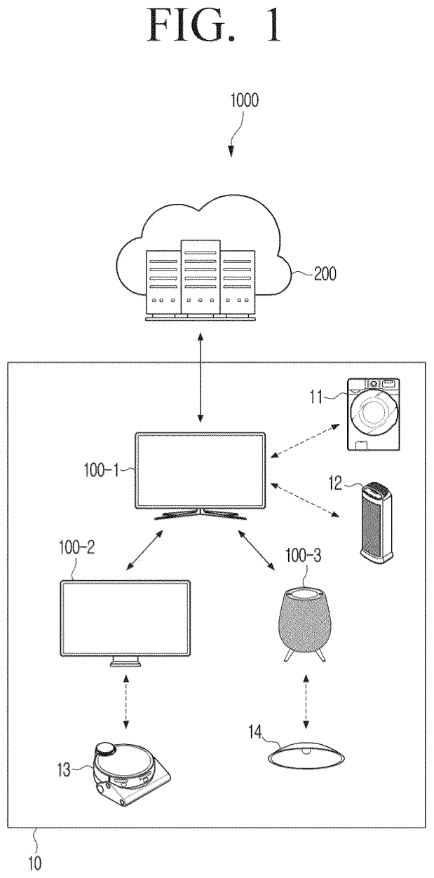

FIG. 1 is a diagram for describing the AP network 10 according to an embodiment.

Referring to FIG. 1, a system 1000 may include an access point (AP) network 10 and a server 200.

The AP network 10 may include a network for managing at least one device by providing a wireless Internet environment. The AP network 10 may be described as an Internet of Things (IoT) network, a wireless network, a wireless Internet access network, a local network, a local AP network, etc.

The AP network 10 may include and connect to at least one device, which may be classified according to a function and role.

Devices of the AP network 10 may be classified into hub devices 100-1, 100-2, and 100-3 and end devices 11, 12, 13, and 14 depending on whether or not the devices may perform a hub function.

The hub function may include a function that may perform a communication connection with the server 200. In order to connect to the server 200 existing in an external network of the AP network 10, the server 200 should include a predetermined communication interface capable of communicating with the server 200. Depending on the device type, it may not include a predetermined communication interface.

Devices that may perform hub functions may be classified as the hub devices 100-1, 100-2, and 100-3. The hub devices 100-1, 100-2, and 100-3 may include devices having a predetermined communication interface. The hub devices 100-1, 100-2, and 100-3 may connect to the server 200 through the predetermined communication interface. The hub devices 100-1, 100-2, and 100-3 may connect to the end devices 11, 12, 13, and 14. The hub devices 100-1, 100-2, and 100-3 may connect to the end devices 11, 12, 13, and 14 through various communication methods.

The hub devices 100-1, 100-2, and 100-3 may be described as a gateway device, a bridge device, etc. For example, the hub devices 100-1, 100-2, and 100-3 may include a television (TV), monitor, a refrigerator, a sound bar, etc.

Devices that may not perform the hub function may be classified as the end devices 11, 12, 13, and 14. The end devices 11, 12, 13, and 14 may include devices that do not have the predetermined communication interface. The end devices 11, 12, 13, and 14 may connect to the hub devices 100-1, 100-2, and 100-3.

The end devices 11, 12, 13, and 14 may be described as a terminal device, a user device, etc. For example, the end devices 11, 12, 13, and 14 may include a lighting device, a sensor, a dryer, a washing machine, etc. The sensor may include at least one of a motion sensor, an image sensor, and a light sensor. End devices capable of performing data processing, such as a sensor, may be described as edge devices.

The hub devices 100-1, 100-2, and 100-3 may be classified into a main hub devices 100-1 or sub-hub devices 100-2 and 100-3 based on whether they are connected to the server 200.

The main hub device 100-1 may include a hub device directly connected to the server 200. The main hub device 100-1 may be described as a master hub device, a main hub device, a first type hub device, etc.

The sub hub devices 100-2 and 100-3 may include hub devices that have a communication interface capable of connecting to the server 200 but are not directly connected to the server 200. The sub hub devices 100-2 and 100-3 may be described as an auxiliary hub device, a second type hub device, etc.

The main hub device 100-1 may communicate with the server 200 using the first communication method. The first communication method may include a communication method using the Internet protocol. For example, the first communication method may include at least one of wireless local area network (LAN), wired LAN, long-term evolution (LTE), and 5G.

The main hub device 100-1 may communicate with the sub hub devices 100-2 and 100-3 using a second communication method. The second communication method may include a short range communication method used in a local network. For example, the second communication method may include at least one of Bluetooth, Bluetooth Low Energy (BLE), Wi-Fi, Zigbee, Z-Wave, Wi-Fi Direct, wireless LAN, wired LAN, and Tread.

The main hub device 100-1 and the sub hub devices 100-2 and 100-3 may communicate with the end devices 11, 12, 13, and 14 using a third communication method. The third communication method may include a short range communication method used in a local network. For example, the third communication method may include at least one of Bluetooth, Bluetooth Low Energy (BLE), Wi-Fi, Zigbee, Z-Wave, Wi-Fi Direct, wireless LAN, wired LAN, and Tread.

According to various embodiments, the first communication may be different than the second communication method, and the first communication may be different than the third communication method.

According to various embodiments, the second communication method and the third communication method may be the same.

According to various embodiments, the second communication method and the third communication method may be different. For example, the second communication method may be BLE communication, and the third communication method may be Zigbee or Z-Wave.

According to various embodiments, the hub device may include a user terminal device or a home appliance capable of providing services to a user. For example, the hub device may include at least one of a display, a speaker, a microphone, and a motor.

The server 200 may include a server that manages devices included in the AP network 10. The server 200 may perform functions such as account management, communication management, security management, remote control, and maintenance in relation to the AP network 10.

The server 200 may be described as a platform server, an IoT platform server, cloud server, an external server, etc.

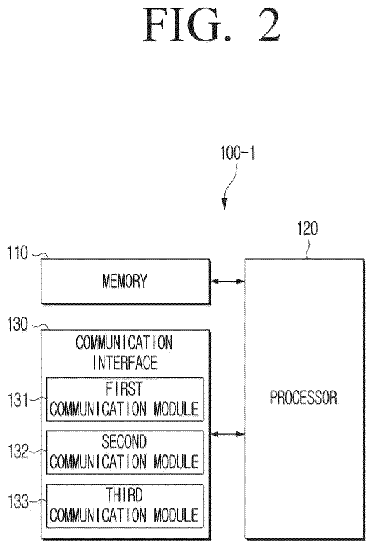

FIG. 2 is a block diagram illustrating a hub device according to an embodiment.

Referring to FIG. 2, the first hub device 100-1 may include at least one of a memory 110, at least one processor 120, and a communication interface 130.

In addition to the first hub device 100-1, the second hub device 100-2 and the third hub device 100-3 may also include the same configuration as the first hub device 100-1.

The memory 110 may store a candidate list and a connection list generated by the first hub device 100-1.

At least one processor 120 may perform various operations performed in the first hub device 100-1 using components included in the first hub device 100-1.

The communication interface 130 may include at least one of a first communication module (i.e., a first communication interface) 131, a second communication module (i.e., a second communication interface) 132, and a third communication module (i.e., a third communication interface) 133 according to the communication method.

At least one processor 120 may connect to the server 200 through the first communication module 131 and may connect to the second hub device 100-2 through the second communication module 132.

The first communication module 131 may be an interface that uses a first communication method. It may include a communication method using the Internet protocol. For example, the first communication method may include at least one of wireless LAN, wired LAN, LTE, and 5G.

The second communication module 132 may be an interface that uses a second communication method. The second communication method may include a short range communication method used in a local network. For example, the second communication method may include at least one of Bluetooth, Bluetooth Low Energy (BLE), Wi-Fi, Zigbee, and Z-Wave.

The third communication module 133 may be an interface that uses a third communication method. The third communication method may include a short range communication method used in a local network. For example, the third communication method may include at least one of Bluetooth, Bluetooth Low Energy (BLE), Wi-Fi, Zigbee, and Z-Wave.

At least one processor 120 may communicate with the server 200 using the first communication module 131. At least one processor 120 may transmit a signal (or information, or data) to the server 200 through the first communication module 131. At least one processor 120 may receive a signal from the server 200 through the first communication module 131.

At least one processor 120 may communicate with other hub devices 100-2 and 100-3 using the second communication module 132. At least one processor 120 may transmit a signal (or information, or data) to other hub devices 100-2 and 100-3 through the second communication module 132. At least one processor 120 may receive signals from other hub devices 100-2 and 100-3 through the second communication module 132.

The second communication module 132 may be described as a hub scanner.

At least one processor 120 may communicate with the end devices 11 and 12 using the third communication module 133. At least one processor 120 may transmit a signal (or information, or data) to the end devices 11 and 12 through the third communication module 133. At least one processor 120 may receive signals from the end devices 11 and 12 through the third communication module 133.

According to various embodiments, the first communication may be different than the second communication method, and the first communication may be different than the third communication method.

According to various embodiments, the second communication method and the third communication method may be the same.

According to various embodiments, the second communication method and the third communication method may be different. For example, the second communication method may be BLE communication, and the third communication method may be Zigbee or Z-Wave.

When a predetermined event is identified, the at least one processor 120 broadcasts a connection request to search for a device that may connect to the server 200 through the communication interface 130.

When a connection response corresponding to a connection request for discovery is received from another hub device, such as the second hub device 100-2, at least one processor 120 may acquire a candidate list including the first hub device 100-1 and the second hub device 100-2.

The at least one processor 120 may store the candidate list in memory 110.

The at least one processor 120 may transmit the candidate list to the second hub device 100-2 through the communication interface 130.

A predetermined event may include an event for generating a candidate list. An event for generating a candidate list may include at least one of an event in which a user input for generating a candidate list is received and an event in which a command for generating a candidate list is received.

When it is determined that a predetermined event has occurred, at least one processor 120 may broadcast a connection request through the second communication module 132. The connection request may include a signal to search for peripheral hub devices.

The connection request may be a signal to search for a hub device to perform a hub function. At least one processor 120 may broadcast a connection request to peripheral devices. At least one processor 120 may wait for a signal (connection response) in response to the connection request.

The connection request may be described as a first signal, a connection request signal, a signal for a connection request, a signal packet for a connection request, a scan signal, etc.

The connection response may be described as a second signal, a connection response signal, a signal for a connection response, a signal packet including a connection response, a response signal, etc.

At least one processor 120 may receive a connection response through the second communication module 132. At least one processor 120 may determine from which device the connection response was transmitted. At least one processor 120 may identify the device that has transmitted the connection response as the second hub device 100-2.

The connection response may include a signal corresponding to the connection request. The connection response may include information indicating a state in which the communication with the server 200 is possible. The connection response may include information indicating a state in which the hub function may be performed. The connection response may include information indicating the device that has transmitted the connection response includes a communication module (e.g., first communication method) for performing a hub function.

When the connection response is received, at least one processor 120 may determine whether the second hub device 100-2, which transmits the connection response, may perform the hub function. For example, the at least one processor 120 may determine the second hub device 100-2 may perform the hub function based on the connection response including information indicating the device that has transmitted the connection response includes a communication module (e.g., first communication method) for performing the hub function.

At least one processor 120 may generate a candidate list representing devices capable of performing a hub function in the AP network 10.

The candidate list may include information related to at least one hub device capable of performing a hub function in the AP network 10 including the first hub device 100-1.

The candidate list may include a list of devices capable of communicating with the server 200 in the AP network 10. The candidate list may include identification information of the hub devices. The candidate list may include identification information of the end devices connected to the hub devices.

Upon acquiring the candidate list, at least one processor 120 may store the candidate list in the memory 110.

Upon acquiring the candidate list, at least one processor 120 may share the candidate list with the second hub device 100-2 included in the candidate list. At least one processor 120 may transmit the candidate list to the second hub device 100-2 using the second communication module 132.

The second hub device 100-2 may receive the candidate list from the first hub device 100-1. The second hub device 100-2 may store the received candidate list in the memory of the second hub device 100-2.

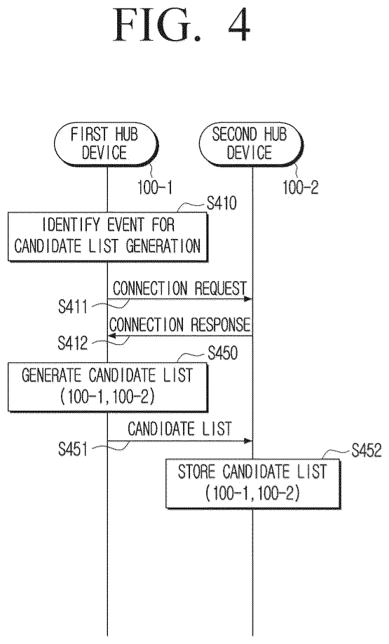

The operation of generating the candidate list is described in FIG. 4.

When a connection response is received using a predetermined communication method, at least one processor 120 may obtain a candidate list including the first hub device 100-1 and the second hub device 100-2. The predetermined communication method may be the Bluetooth Low Energy (BLE) communication.

At least one processor 120 may check whether the connection response has been properly received. At least one processor 120 may check whether the connection response has been received using a predetermined communication method.

When the connection response is received from the second hub device 100-2 using the predetermined communication method, the at least one processor 120 may determine the second hub device 100-2 may perform the hub function and is included in the AP network 10.

When the connection response is not received from the second hub device 100-2 using the predetermined communication method, the at least one processor 120 may determine the second hub device 100-2 may be determined as a device that may not perform the hub function.

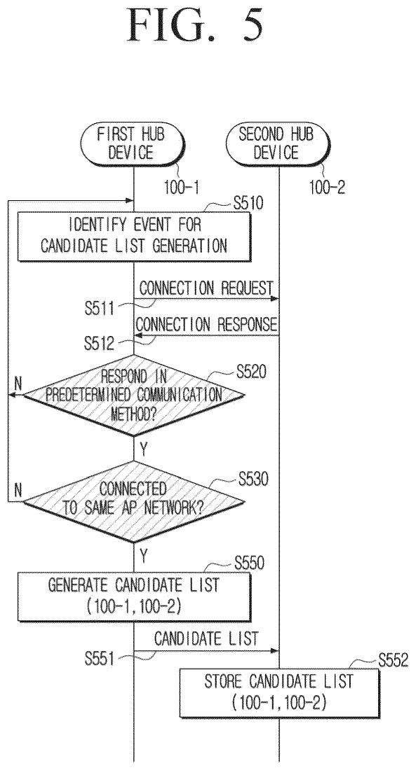

The operations related to this are described in FIG. 5.

At least one processor 120 may acquire a candidate list including identification information of the second hub device 100-2 based on the connection response.

The connection response may include identification information of the second hub device 100-2 that has transmitted the connection response. At least one processor 120 may identify that the second hub device 100-2 has transmitted the connection response based on the identification information included in the connection response. The identification information included in the candidate list may be used to determine a partner to transmit a signal.

At least one processor 120 may generate the candidate list including the first identification information of the first hub device 100-1 and the second identification information of the second hub device 100-2.

The identification information may include medium access control (MAC) address information. The connection response may include MAC address information of the second hub device 100-2.

At least one processor 120 may generate a candidate list based on the MAC address information of the second hub device 100-2 included in the connection response.

At least one processor 120 may generate a candidate list including first MAC address information of the first hub device 100-1 and second MAC address information of the second hub device 100-2.

The connection request is a first connection request, the connection response is a first connection response, the candidate list is a first candidate list, and at least one processor 120 may broadcast a second connection request when the event detected by the third hub device 100-3 is identified, acquire a second candidate list including the first hub device 100-1, the second hub device 100-2, and the third hub device 100-3 when receiving a second connection response corresponding to the second connection request from the third hub device 100-3, update the first candidate list (stored in memory 110) to the second candidate list, and transmit the second candidate list to the second hub device 100-2 and the third hub device 100-3 through the communication interface 130.

At least one processor 120 may broadcast a second connection request through the second communication module 132. At least one processor 120 may receive a second connection response through the second communication module 132.

At least one processor 120 may transmit the second candidate list to the second hub device 100-2 and the third hub device 100-3 through the second communication module 132.

The event in which the third hub device 100-3 is detected may include at least one of an event in which the first hub device 100-1 directly detects the third hub device 100-3, an event in which the second hub device 100-2 detects the third hub device 100-3, and an event in which the third hub device 100-3 broadcasts a signal representing itself.

The second candidate list may include first identification information of the first hub device 100-1, second identification information of the second hub device 100-2, and third identification information of the third hub device 100-3.

According to various embodiments, at least one processor 120 may update the candidate list based on an event for updating the candidate list instead of an event in which the third hub device 100-3 is detected.

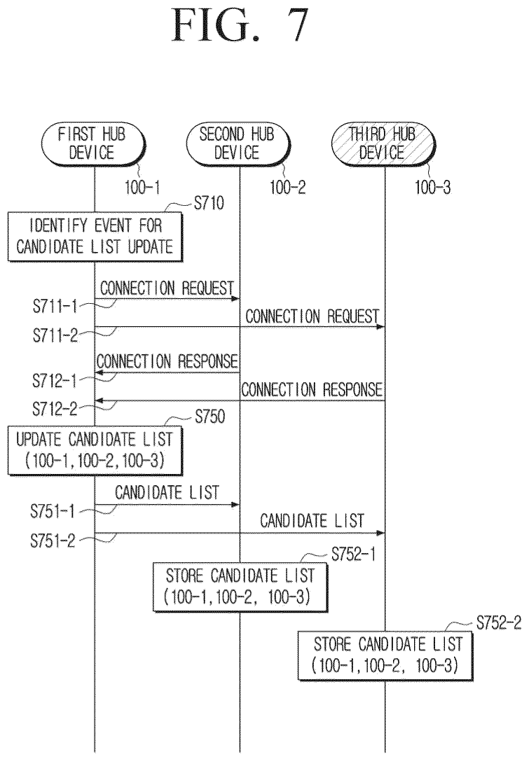

The operation of updating the candidate list is described with reference to FIGS. 7, 8, and 9.

At least one processor 120 may broadcast a third connection request when an event is identified in which the third hub device 100-3 is not detected, acquire a third candidate list including the first hub device 100-1 and the second hub device 100-2 when a response corresponding to the third connection request is not received from the third hub device 100-3 within a predetermined time, update the second candidate list (stored in the memory 110) to the third candidate list, and transmit the third candidate list to the second hub device 100-2 through the communication interface 130.

At least one processor 120 may broadcast a third connection request through the second communication module 132. At least one processor 120 may determine whether a response corresponding to the third connection request is received through the second communication module 132.

At least one processor 120 may transmit the third candidate list to the second hub device 100-2 through the second communication module 132.

An event in which the third hub device 100-3 is not detected may include at least one of the event in which the first hub device 100-1 does not directly detect the third hub device 100-3, the event in which the second hub device 100-2 does not directly detect the third hub device 100-3, and the event in which the third hub device 100-3 broadcasts a signal indicating that the third hub device 100-3 is terminating its communication session.

The third candidate list may include first identification information of the first hub device 100-1 and second identification information of the second hub device 100-2.

According to various embodiments, at least one processor 120 may update the candidate list based on an event (e.g., user input) for updating the candidate list instead of the event the third hub device 100-3 is not detected.

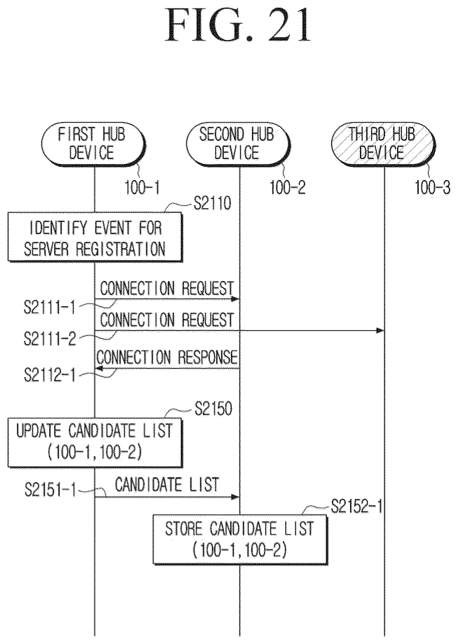

The operation of updating the candidate list is described in FIG. 21.

When a user input for registration is received, at least one processor 120 may transmit an activation request to the second hub device 100-2 included in the candidate list through the communication interface 130, generate the connection list including the first hub device 100-1 and the second hub device 100-2 when the activation response corresponding to the activation request is received from the second hub device 100-2, and transmit the connection list to the server 200 through the communication interface 130.

When identifying an event for registration, at least one processor 120 may request the registration from the server 200.

The event for registration may include an event for registering at least one of the hub device(s) included in the candidate list on the server 200. The hub device which requested the registration should be registered on the server 200 to receive the signal from the server 200. The server 200 may transmit the signal only to the registered device.

The event for registration may be described as an event for server registration. The event for server registration may include an event in which the user input is received to register (or upload) the information about the hub device on the server.

When the event for registration is identified, at least one processor 120 may determine a main hub device and a sub-hub device based on the candidate list.

It is assumed that the event for registration is an event that receives the user input. At least one processor 120 may determine the hub device corresponding to the user input as the main hub device. At least one processor 120 may determine the remaining hub devices other than the hub device determined as the main hub device among the plurality of hub devices included in the candidate list as the sub-hub devices.

It is assumed that the first hub device 100-1 is the main hub device, and the sub-hub device is the second hub device 100-2.

The main hub device may include a hub device directly connected to the server 200. The main hub device may be described as a master hub device, a main hub device, a first type hub device, etc.

The sub-hub device may include a hub device that has a communication interface capable of connecting to the server 200, but is not directly connected to the server 200. The sub hub device may be described as an auxiliary hub device, a second type hub device, etc. For example, each sub-hub device may connect to the server through the main hub device.

The activation request may be a request to confirm whether the hub device that transmitted the activation request may operate as the sub-hub device in the AP network 10.

The activation request may include at least one of an activation request signal, an activation signal packet, a signal requesting a sub-hub function, a signal granting sub-hub device authority, and a signal to notify that the hub device that transmitted the activation request operates as a sub-hub device.

The activation response may include a response indicating that the hub device that transmitted the activation request may operate as a sub hub device in response to the activation request.

At least one processor 120 may transmit an activation request to the second hub device 100-2 based on identification information included in the candidate list. At least one processor 120 may confirm whether a signal (activation response) responding to the activation request is received. When the activation response is received, at least one processor 120 may generate a connection list including the hub device that has transmitted the activation response.

At least one processor 120 may classify hub devices included in the candidate list as main hub devices or sub-hub devices. At least one processor 120 may transmit the classification result to the second hub device 100-2 based on the activation request. At least one processor 120 may confirm that the second hub device 100-2 may perform as a sub-hub device based on the activation response.

After the confirmation, at least one processor 120 may generate the connection list including the first hub device 100-1 and the second hub device 100-2.

Unlike the candidate list, the connection list may additionally include type information.

The connection list may include the information about the main hub device or sub hub device. The connection list may include device identification information and device type information.

The type information may be information indicating whether a hub device operates as a main hub device or a sub-hub device. When operating as the main hub device, the type information may indicate the first type (or main type). When operating as the sub-hub device, the type information may indicate a second type (or sub-type).

For example, the connection list may include the identification information of the first hub device 100-1 and the type information (main type) of the first hub device 100-1. The connection list may include the identification information of the second hub device 100-2 and the type information (subtype) of the second hub device 100-2.

At least one processor 120 may transmit the activation request to the second hub device 100-2 through the second communication module 132.

At least one processor 120 may receive the activation response from the second hub device 100-2 through the second communication module 132.

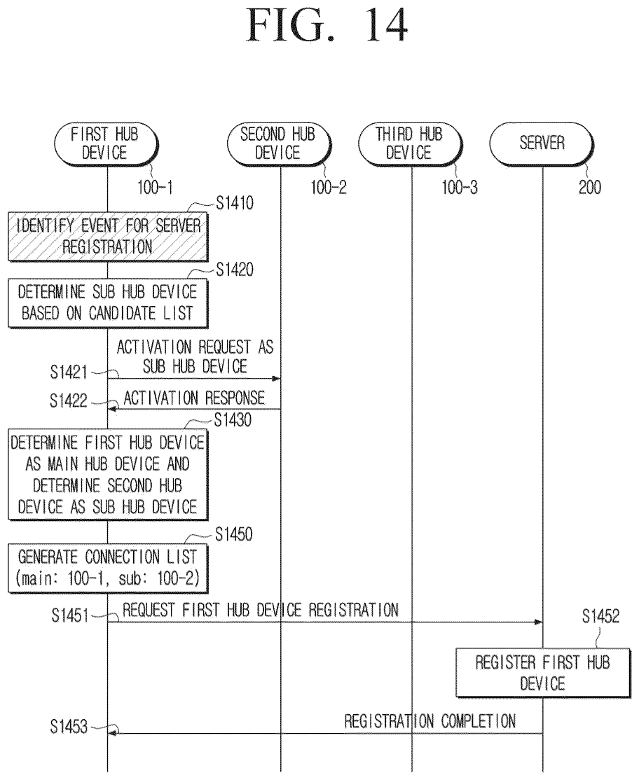

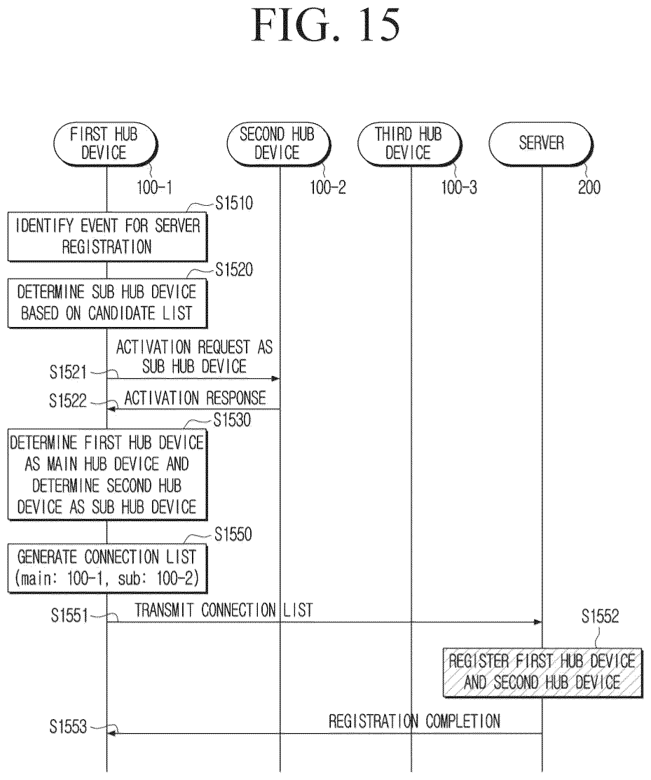

The operations related to the registration are described in FIGS. 14 and 15.

When the control command for controlling the end device 13 connected to the second hub device 100-2 is received from the server 200, at least one processor 120 may transmit the control command to the second hub device 100-2 through the communication interface 130.

At least one processor 120 may receive the control command from the server 200 using the first communication module 131. At least one processor 120 may transmit the control command to the second hub device 100-2 using the second communication module 132.

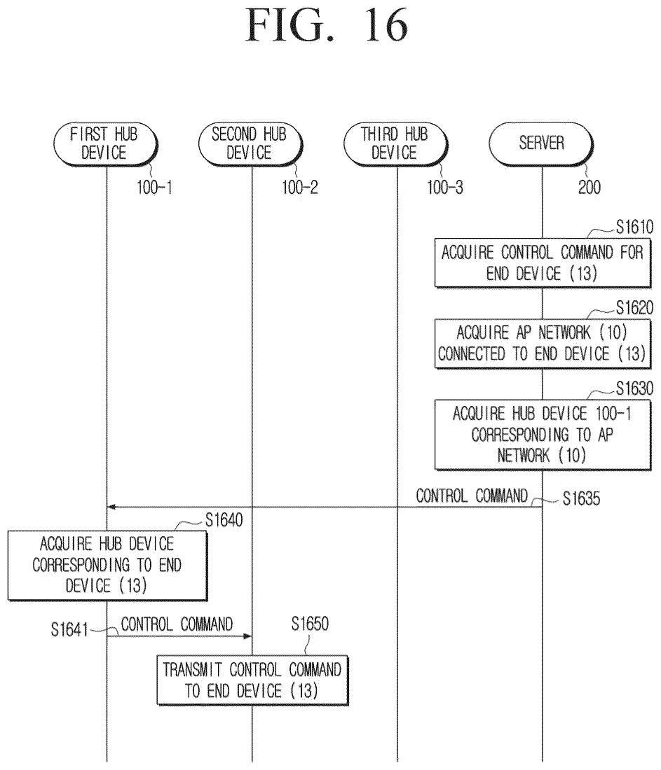

The operation of transmitting the control command to the end device is described in FIGS. 16, 17, and 18.

According to various embodiments, it is assumed that at least one processor 120 has received the control command for controlling the end devices 11 and 12 connected to the first hub device 100-1. At least one processor 120 may transmit the control command to the end devices 11 and 12 using the third communication module 133.

When the control information related to the end device 13 connected to the second hub device 100-2 is received from the second hub device 100-2, the at least one processor 120 may transmit the control information to the server 200 through the communication interface 130.

The control information may include various information transmitted from the end device to the server 200. The control information may include at least one of sensing information, control result information, and information corresponding to a control command.

At least one processor 120 may receive the control information from the second hub device 100-2 using the second communication module 132. At least one processor 120 may transmit the control information to the server 200 using the first communication module 131.

According to various embodiments, it is assumed that at least one processor 120 has received the control information from the end devices 11 and 12 connected to the first hub device 100-1. At least one processor 120 may receive the control information from the end devices 11 and 12 using the third communication module 133.

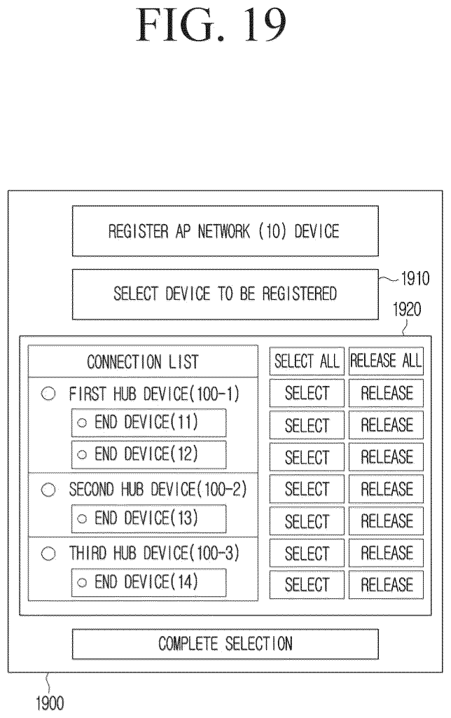

The first hub device 100-1 further includes a display 140, and at least one processor 120 may display a guide screen including a connection list through the display 140, and may transmit the registration request for the first hub device 100-1 to the server 200 through the communication interface 130 when the user input for registering the first hub device 100-1 is received through the guide screen. The descriptions related to this are described in FIG. 19.

The candidate list may be written as a first list or a first type list.

The candidate list may be written as the candidate hub list, the candidate hub device list, etc.

The connection list may be described as a second list or a second type list.

The connection list may be described as the connection hub list, the connection hub device list, the sub hub list, the sub hub device list, etc.

The connection list may be described as a hierarchical list, a hierarchical hub list, a hierarchical hub device list, etc.

The connection list may be described as a cluster list, a cluster hub list, a cluster hub device list, etc.

According to various embodiments, without distinguishing between the candidate list and the connection list, each list may be described as a first list, a second list, a third list, etc.

According to various embodiments, the candidate list may be pre-stored in the first hub device 100-1, and in the regard the first hub device 100-1 may already be in a state of storing the candidate list. The candidate list may include information about other hub devices that may connect (or may be connected) to the first hub device 100-1. For example, the candidate list may include information about the second hub device 100-2. The candidate list may include information about a plurality of hub devices included in the AP network 10. The candidate list may be stored in each hub device included in the AP network 10. The candidate list may be stored in the first hub device 100-1, the second hub device 100-2, the third hub device 100-3, etc. The first hub device 100-1 may update the candidate list and transmit the updated candidate list to the second hub device 100-2.

The administrator may easily recognize hub devices that may connect to the AP network 10 through the candidate list. In addition, it is possible to easily configure a multi-hub through the connection list. Users only need to register one hub without performing a separate multi-hub configuration operation, and there is no need to perform separate additional registration for the remaining hubs. Users may easily use the IoT network to manage the multiple hub devices.

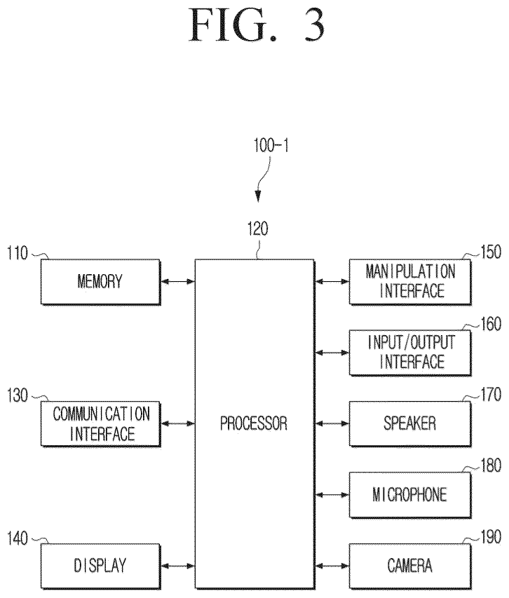

FIG. 3 is a block diagram for describing a detailed configuration of the hub device of FIG. 2 according to an embodiment.

FIG. 3 is a block diagram for describing the specific configuration of the first hub device 100-1 of FIG. 2.

Referring to FIG. 3, the first hub device 100-1 may include at least one of a memory 110, at least one processor 120, a communication interface 130, a display 140, an operation interface 150, an input/output interface 160, a speaker 170, a microphone 180, and a camera 190.

The memory 110 may be implemented by an internal memory such as a read-only memory (ROM) (for example, an electrically erasable programmable read-only memory (EEPROM)), a random access memory (RAM), or the like, included in at least one processor 120 or be implemented by a memory separate from at least one processor 120. The memory 110 may be implemented in the form of a memory embedded in the first hub device 100-1 or in the form of a memory detachable from the first hub device 100-1, depending on the data storage purpose. For example, in the case of data for driving the first hub device 100-1, it is stored in the memory embedded in the first hub device 100-1, and in the case of data for the expansion function of the first hub device 100-1, it may be stored in the memory that is detachable from the first hub device 100-1.

The memory embedded in the hub device 100-1 may be implemented by at least one of a volatile memory (for example, a dynamic RAM (DRAM), a static RAM (SRAM), a synchronous dynamic RAM (SDRAM), or the like) or a non-volatile memory (for example, a one time programmable ROM (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash, or the like), a hard drive, or a solid state drive (SSD)), and the memory attachable to and detachable from the hub device 100-1 may be implemented in a form such as a memory card (for example, a compact flash (CF), a secure digital (SD), a micro-SD, a mini-SD, an extreme digital (xD), a multi-media card (MMC), or the like), an external memory (for example, a universal serial bus (USB) memory) connectable to a USB port, or the like.

The memory 110 may store at least one instruction. At least one processor 120 may perform various operations based on instructions stored in the memory 110.

At least one processor 120 may be implemented by a digital signal processor (DSP), a microprocessor, or a time controller (TCON) that processes a digital signal. However, the processor 130 is not limited thereto, and may include one or more of a central processing unit (CPU), a micro controller unit (MCU), a micro processing unit (MPU), a controller, an application processor, a graphics-processing unit (GPU), a communication processor (CP), and an advanced reduced instruction set computer (RISC) machines (ARM) processor, or may be defined by these terms. At least one processor 120 may be implemented by a system-on-chip (SoC) or a large scale integration (LSI) in which a processing algorithm is embedded, or may be implemented in a field programmable gate array (FPGA) form. At least one processor 120 may perform various functions by executing computer executable instructions stored in the memory.

The communication interface 130 is a component performing communication with various types of external apparatuses depending on various types of communication manners. The communication interface 130 may include a wireless communication module or a wired communication module. Each communication module may be implemented in the form of at least one hardware chip.

The wireless communication module may be an interface that communicates wirelessly with an external device. For example, the wireless communication module may include at least one of a Wi-Fi module, a Bluetooth module, an infrared communication module, or other communication modules.

The Wi-Fi module and the Bluetooth module perform communication in a Wi-Fi method and a Bluetooth method, respectively. In the case of using the Wi-Fi module or the Bluetooth module, various connection information such as a service set identifier (SSID), a session key, and the like, is first transmitted and received, communication is connected using the connection information, and various information may then be transmitted and received.

The infrared communication module performs communication according to an infrared data association (IrDA) technology of wirelessly transmitting data to a short distance using an infrared ray positioned between a visible ray and a millimeter wave.

Other communication modules may include at least one communication chip performing communication according to various wireless communication standards such as Zigbee, 3rd generation (3G), 3rd generation partnership project (3GPP), long term evolution (LTE), LTE advanced (LTE-A), 4th generation (4G), 5th generation (5G), and the like, in addition to the communication manner described above.

The wired communication module may be an interface that communicates with an external device by wire. For example, the wired communication module may include at least one of a local area network (LAN) module, an Ethernet module, a pair cable interface, a coaxial cable interface, a fiber optic cable interface, or an ultra-wideband (UWB) module.

According to an example, the communication interface 130 may use the same communication module (for example, the Wi-Fi module) to communicate with an external device such as a remote control and an external server.

According to an example, the communication interface 130 may use different communication modules to communicate with an external device, such as a remote control, and an external server. For example, the communication interface 130 may use at least one of the Ethernet module or the Wi-Fi module to communicate with the external server, and may use the Bluetooth module to communicate with the external device such as the remote control. However, this is only an example, and the communication interface 130 may use at least one of various communication modules in a case in which it communicates with a plurality of external devices or external servers.

The display 140 may be implemented by various types of displays such as a liquid crystal display (LCD), an organic light emitting diode (OLED) display, a plasma display panel (PDP), and the like. A driving circuit, a backlight unit, and the like, that may be implemented in a form such as amorphous silicon (A-Si) thin film transistor (TFT), low temperature poly silicon (LTPS) TFT, an organic TFT (OTFT), and the like, may be included in the display 140. The display 140 may be implemented as a touch screen combined with a touch sensor, a flexible display, a three-dimensional display, etc. According to an embodiment, the display 140 may include a bezel housing the display panel as well as a display panel that outputs an image. In particular, according to an embodiment, the bezel may include a touch sensor for detecting user interaction.

The manipulation interface 150 may be implemented as a device such as a button, a touch pad, a mouse, and a keyboard, or may be implemented as a touch screen capable of performing the above-described display function and manipulation input function together. The button may be various types of buttons such as a mechanical button, a touch pad, a wheel, and the like, formed in any region such as a front surface portion, a side surface portion, a rear surface portion, and the like, of a body appearance of the first hub device 100-1.

The input/output interface 160 may be an interface of any one of a high definition multimedia interface (HDMI), a mobile high-definition link (MHL), a universal serial bus (USB), a display port (DP), Thunderbolt, a video graphics array (VGA) port, an RGB port, a D-subminiature (D-SUB), and a digital visual interface (DVI). The input/output interface 160 may input/output at least one of audio and video signals. Depending on the implementation, the input/output interface 160 may include a port for inputting/outputting only an audio signal and a port for inputting/outputting only a video signal as separate ports, or may be implemented as a single port for inputting/outputting both an audio signal and a video signal. The first hub device 100-1 may transmit at least one of audio and video signals to an external device (e.g., an external display device or an external speaker) through the input/output interface 160. The output port included in the input/output interface 160 may connect to an external device, and the first hub device 100-1 may transmit at least one of an audio and video signal to the external device through the output port.

The input/output interface 160 may be connected to the communication interface. The input/output interface 160 may transmit information received from an external device to a communication interface or transmit information received through the communication interface to an external device.

The speaker 170 may be a component that outputs not only various audio data but also various notification sounds, voice messages, or the like.

The microphone 180 is a component for receiving a user voice or other sounds and converting the user voice or other sounds into audio data. The microphone 180 may receive the user voice when activated. For example, the microphone 180 may be formed integrally with the first hub device 100-1 in upper, front, side directions, or the like. The microphone 180 may include various components such as a microphone collecting the user voice in the analog form, an amplifier circuit amplifying the collected user voice, an A/D conversion circuit sampling the amplified user voice and converting the sampled amplified user voice into a digital signal, and a filter circuit removing noise components from the converted digital signal.

The camera 190 is configured to generate a captured image by capturing a subject, in which the captured image is a concept including both a moving image and a still image. The camera 190 may acquire an image of at least one external device, and may be implemented as a camera, a lens, an infrared sensor, or the like.

The camera 190 may include a lens and an image sensor. The lens may include a general-purpose lens, a wide-angle lens, a zoom lens, and the like, and the type of lens may be determined according to the type, characteristic, use environment, and the like of the hub device 100-1. In some embodiments, the camera 190 may include multiple image sensors and multiple lenses having different focal lengths. As the image sensor, a complementary metal oxide semiconductor (CMOS), a charge coupled device (CCD), and the like may be used.

According to various embodiments, the first hub device 100-1 may include the display 140. The first hub device 100-1 may directly display the acquired image or content on the display 140.

According to various embodiments, the first hub device 100-1 may not include the display 140. The first hub device 100-1 may connect to an external display device and may transmit an image or content stored in the first hub device 100-1 to the external display device.

The first hub device 100-1 may transmit an image or content to an external display device along with a control signal for controlling the image or content to be displayed on the external display device. The external display device may connect to the first hub device 100-1 through the communication interface 130 or the input/output interface 160. For example, the first hub device 100-1 may not include a display like a set top box (STB).

The first hub device 100-1 may include a small display capable of displaying only simple information such as text information. Here, the first hub device 100-1 may transmit the image or content to the external display device wired or wirelessly through the communication interface 130, or may transmit the image or content to the external display device through the input/output interface 160 while displaying simple information on the small display.

There may be various embodiments in which the first hub device 100-1 performs an operation corresponding to a user voice signal received through the microphone 180.

According to various embodiments, the first hub device 100-1 may control the display 140 based on a user voice signal received through the microphone 180. For example, when the user voice signal for displaying content A is received, the first hub device 100-1 may control the display 140 to display content A.

According to various embodiments, the first hub device 100-1 may control the external display device connected to the first hub device 100-1 based on the user voice signal received through the microphone 180. Specifically, the first hub device 100-1 may generate a control signal for controlling the external display device so that an operation corresponding to the user voice signal is performed on the external display device, and may transmit the generated control signal to the external display device. Here, the first hub device 100-1 may store a remote control application for controlling an external display device. In addition, the first hub device 100-1 may transmit the generated control signal to the external display device using at least one communication method among Bluetooth, Wi-Fi, or infrared rays. For example, when the user voice signal for displaying content A is received, the first hub device 100-1 may transmit a control signal to the external display device for controlling the content A to be displayed on the external display device. Here, the first hub device 100-1 may refer to various terminal devices capable of installing remote control applications such as a smart phone and an AI speaker.

According to various embodiments, the first hub device 100-1 may use a remote control device for controlling the external display device connected to the first hub device 100-1 based on the user voice signal received through the microphone 180. Specifically, the first hub device 100-1 may transmit, to the remote control device, the control signal for controlling the external display device so that an operation corresponding to the user voice signal is performed on the external display device. The remote control device may transmit the control signal received from the first hub device 100-1 to the external display device. For example, when the user voice signal for displaying the content A is received, the first hub device 100-1 may transmit the control signal for controlling the content A to be displayed on the external display device to the remote controller, and the remote control device may transmit the received control signal to the external display device.

The first hub device 100-1 may receive user voice signals in various ways.

According to various embodiments, the first hub device 100-1 may receive a user voice signal through the microphone 180 included in the first hub device 100-1.

According to various embodiments, the first hub device 100-1 may receive a user voice signal from an external device including a microphone. For example, the external device may be a remote control device or smartphone, etc. The received user voice signal may be a digital voice signal, but embodiments are not limited thereto and the received user voice signal may be an analog voice signal. The first hub device 100-1 may receive a user voice signal through a wireless communication method such as Bluetooth or Wi-Fi.

The first hub device 100-1 may convert user voice signals in various ways.

According to various embodiments, the first hub device 100-1 may acquire text

information corresponding to the user voice signal from an external server. The first hub device 100-1 may transmit a user voice signal (audio signal or digital signal) to an external server. The external server may be a voice recognition server. The voice recognition server may convert the user voice signal into text information using speech to text (STT). In addition, the external server may transmit the text information corresponding to the converted user voice signal to the first hub device 100-1.

According to various embodiments, the first hub device 100-1 itself may acquire text information corresponding to the user voice signal. The first hub device 100-1 may apply the speech to text (STT) function directly to the digital voice signal, convert the STT into the text information, and transmit the converted text information to the external server.

The external server may transmit the information to the first hub device 100-1 in various ways.

According to various embodiments, the external server may transmit the text information corresponding to the user voice signal to the first hub device 100-1. The external server may be a server that performs a voice recognition function that converts the user voice signal into the text information.

According to various embodiments, the external server may transmit at least one of text information corresponding to the user voice signal or search result information corresponding to the text information to the first hub device 100-1. The external server may be a server that performs a search result providing function that provides the search result information corresponding to the text information in addition to a voice recognition function that converts the user voice signal into the text information. For example, the external server may be a server that performs both the voice recognition function and the search result providing function. As another example, the external server may perform only the voice recognition function and the search result providing function may be performed by a separate server. In order to obtain the search results, the external server may transmit the text information to a separate server and acquire the search results corresponding to the text information from the separate server.

The first hub device 100-1 may communicate with an external device and an external server in various ways.

According to various embodiments, a communication module for communication with the external device and external server may be implemented in the same way. For example, the first hub device 100-1 may communicate with the external device using a Bluetooth module, and may also communicate with an external server using the Bluetooth module.

According to various embodiments, the communication module for communication with the external device and external server may be implemented separately. For example, the first hub device 100-1 may communicate with the external device using a Bluetooth module and communicate with the external server using an Ethernet modem or Wi-Fi module.

FIG. 4 is a diagram for describing an operation of generating a candidate list, according to an embodiment.

Referring to FIG. 4, it is assumed that initially there is no candidate list in the hub devices included in the AP network 10. It is assumed that the AP network 10 includes the first hub device 100-1 and a second hub device 100-2.

The first hub device 100-1 may identify an event for generating a candidate list (S410). An event for generating a candidate list may include at least one of an event in which a user input for generating a candidate list is received and an event in which a command for generating a candidate list is received.

The first hub device 100-1 included in the AP network 10 may generate the candidate list. When an event for generating a candidate list is identified, the first hub device 100-1 may transmit a connection request to the second hub device 100-2 (S411). The connection request may be a request to confirm whether the second hub device 100-2 may perform the hub function. The connection request may be described as a connection request signal or connection request information. The first hub device 100-1 may broadcast a connection request to peripheral devices. The broadcasting method may include a communication method that transmits a signal to peripheral devices rather than transmitting a signal to a specific device.

The second hub device 100-2 may receive the connection request from the first hub device 100-1. The second hub device 100-2 may confirm whether the second hub device 100-2 may perform the hub function. When the second hub device 100-2 may perform the hub function, the second hub device 100-2 may transmit the connection response to the first hub device 100-1 (S412). The connection response may include at least one of MAC address information, device group information, and capability information. The connection response may be described as the connection response signal or connection response information.

The MAC address information may include access address information necessary to establish (or connect) a communication session. The device group information may include at least one of the functions and/or communication methods that the device may perform.

The device group information may be a group name classified according to predetermined criteria. For example, TV, smartphone, tablet, signage, etc., may be included in the display device type. Air conditioners, air purifiers, ventilators, etc., may be classified into air conditioning device types.

The capability information may include a list of functions that can be performed. For example, a TV may store a list of functions that indicate it may perform an image output function, an audio output function, and a voice recognition function. The TV may transmit the capability information including a list of functions to the first hub device 100-1.

The first hub device 100-1 may receive a connection response from the second hub device 100-2. The first hub device 100-1 may generate the candidate list based on the connection response (S450). The first hub device 100-1 may transmit the generated candidate list to the second hub device 100-2 (S451).

The second hub device 100-2 may receive the candidate list from the first hub device 100-1. The second hub device 100-2 may store the received candidate list (S452).

In the AP network 10, both the first hub device 100-1 and the second hub device 100-2 may store (or share) the same candidate list.

According to various embodiments, the connection response may include support availability information indicating whether the hub function may be performed. The first hub device 100-1 may determine whether the second hub device 100-2 may perform the hub function based on the support availability information. When the second hub device 100-2 is identified as capable of performing the hub function, the first hub device 100-1 may generate the candidate list including the first hub device 100-1 and the second hub device 100-2.

According to various embodiments, the first hub device 100-1 may identify the device that has transmitted the response information. The first hub device 100-1 may generate the candidate list including the identified device (device that has transmitted the response information). For example, the first hub device 100-1 may identify the response information is from the second hub device 100-2 and include the second hub device 100-2 in the candidate list.

FIG. 5 is a diagram illustrating an operation of generating a candidate list by confirming a predetermined communication method, according to an embodiment.

Operations S510, S511, S512, S550, S551, and S552 of FIG. 5 may correspond to operations S410, S411, S412, S450, S451, and S452 of FIG. 4. Redundant descriptions will be omitted.

When the connection response is received in operation S512, the first hub device 100-1 may identify whether the connection response is received using a predetermined communication method (S520). The first hub device 100-1 may determine whether to generate the candidate list based on whether the connection response is received using the predetermined communication method. The predetermined communication method may include a communication method predetermined by the user in generating the candidate list. The predetermined communication method may include a communication method used to perform the hub function. For example, the predetermined communication method may be BLE communication.

When the connection response is not identified as being received using the predetermined communication method (S520-N), the first hub device 100-1 may repeatedly perform operations S510, S511, S512, and S520.

When the connection response is identified as being received using the predetermined communication method (S520-Y), the first hub device 100-1 may determine whether the second hub device 100-2 is connected to the same AP network 10 based on the connection response (S530). The connection response may include information about the AP network 10 to which the second hub device 100-2 is connected (or connectable). The first hub device 100-1 may determine whether the AP network to which it is connected and the AP network information included in the connection response correspond to the same AP network.

When it is not identified as connected to the same AP network 10 (S530-N), the first hub device 100-1 may repeatedly perform operations S510, S511, S512, S520, and S530.

When it is identified the first hub device 100-1 and the second hub device 100-2 are connected to the same AP network 10 (S530-Y), the first hub device 100-1 may generate the candidate list including the first hub device 100-1 and the second hub device 100-2.

The candidate list may include both the first hub device 100-1 and the second hub device 100-2.

According to various embodiments, operation S530 of FIG. 5 may be omitted. When the connection response is identified as being received using the predetermined communication method (S520-Y), the first hub device 100-1 may generate the candidate list including the first hub device 100-1.

According to various embodiments, operation S520 of FIG. 5 may be omitted. Regardless of the predetermined communication method, when the connection response is identified as being received using the predetermined communication method (S520-Y), the first hub device 100-1 may generate the candidate list including the first hub device 100-1 and the second hub device 100-2.

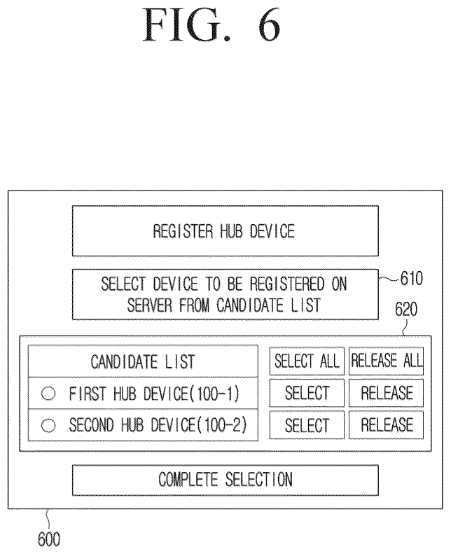

FIG. 6 is a diagram for describing a screen related to a registration operation, according to an embodiment.

Referring to FIG. 6, the first hub device 100-1 may provide a screen 600 for selecting a device to be registered on the server from the candidate list. The screen 600 may include at least one of a user interface (UI) 610 for guiding to select a device to be registered on the server from the candidate list and a UI 620 indicating a device included in the candidate list.

The first hub device 100-1 may receive a user input for selecting a device to register on the server through the UI 620.

According to various embodiments, the first hub device 100-1 may automatically determine a device to register on the server without the user input. As an example, the first hub device 100-1 may determine to register all devices included in the candidate list on the server. As an example, the first hub device 100-1 may determine to register only the predetermined devices among the devices included in the candidate list on the server. The predetermined device may be a device classified as a main hub device.

FIG. 7 is a diagram for describing an operation of updating a candidate list, according to an embodiment.

Referring to FIG. 7, the first hub device 100-1 may identify an event for updating the candidate list (S710). The event for updating the candidate list may include at least one of an event in which the user input for an update is received, an event in which a predetermined period passes, an event in which a predetermined period starts, an event in which new devices are searched, and an event in which an update request is received from an external device. It is assumed that the third hub device 100-3 is additionally included in the AP network 10.

When an event for updating the candidate list is identified, the first hub device 100-1 may broadcast the connection request. The first hub device 100-1 may transmit the connection request to the first hub device 100-1 (S711-1). The first hub device 100-1 may transmit the connection request to the second hub device 100-2 (S711-2).

The second hub device 100-2 may receive the connection request from the first hub device 100-1. The second hub device 100-2 may transmit the connection response to the first hub device 100-1 (S712-1).

The third hub device 100-3 may receive the connection request from the first hub device 100-1. The third hub device 100-3 may transmit the connection response to the first hub device 100-1 (S712-2).

The first hub device 100-1 may receive a connection response from the second hub device 100-2. The first hub device 100-1 may receive a connection response from the third hub device 100-3. The first hub device 100-1 may generate (or update) the candidate list including the first hub device 100-1, the second hub device 100-2, and the third hub device 100-3 based on the received connection responses (S750).

The first hub device 100-1 may transmit the updated candidate list to the second hub device 100-2 (S751-1). The first hub device 100-1 may transmit the updated candidate list to the third hub device 100-3 (S721-2).

The second hub device 100-2 may receive the updated candidate list from the first hub device 100-1. The second hub device 100-2 may store the updated candidate list (S752-1).

The third hub device 100-3 may receive the updated candidate list from the first hub device 100-1. The third hub device 100-3 may store the updated candidate list (S752-2).

The descriptions related to the connection request and connection response are described in FIG. 4. Redundant descriptions will be omitted.

According to various embodiments, during the operation of updating the candidate list, the second hub device 100-2 included in the existing candidate list may not transmit the connection response signal. This is because the determination operation for the already connected second hub device 100-2 may be unnecessary. The first hub device 100-1 may maintain the second hub device 100-2 in the candidate list even if the connection response is not received from the second hub device 100-2.

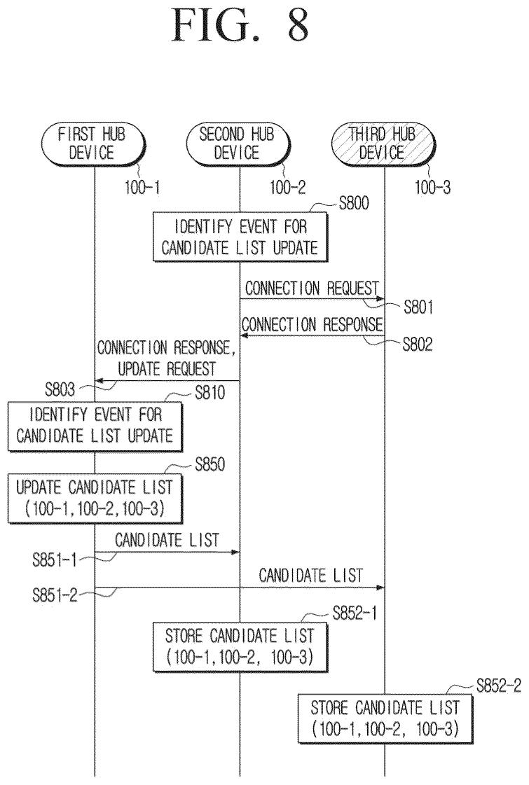

FIG. 8 is a diagram for describing an operation of updating a candidate list, according to an embodiment.

Operations S810, S850, S851-1, S851-2, S852-1, and S852-2 in FIG. 8 may correspond to operations S710, S750, S751-1, S751-2, S752-1, and S752-2 in FIG. 7. Redundant descriptions will be omitted.

Referring to FIG. 8, the second hub device 100-2 may identify an event for updating the candidate list (S800). The event for updating the candidate list may include at least one of an event in which the user input for an update is received, an event in which a predetermined period passes, an event in which a predetermined period starts, an event in which new devices are searched, and an event in which an update request is received from an external device

The second hub device 100-2 included in the AP network 10 may identify whether to connect to a new device. For example, the second hub device 100-2 may search for a new device and determine whether to connect to a new device based on the new device being identified.

According to various embodiments, the second hub device 100-2 may receive the network connection signal broadcast from the third hub device 100-3. Upon receiving a connection signal from the third hub device 100-3, the second hub device 100-2 may determine that the event for updating the candidate list has been identified.

When a signal related to a new device is identified, the second hub device 100-2 may identify that the event for updating the candidate list has been received. The second hub device 100-2 may broadcast the connection request. The second hub device 100-2 may transmit the connection request from the third hub device 100-3 (S801).

The third hub device 100-3 may receive the connection request from the second hub device 100-2. The third hub device 100-3 may transmit the connection response to the second hub device 100-2 (S802).

The second hub device 100-2 may receive the connection response from the third hub device 100-3. The second hub device 100-2 may transmit a signal including the received connection response and update request to the first hub device 100-1.

Upon receiving the connection signal from the second hub device 100-2, the first hub device 100-1 may determine that the event for updating the candidate list has been identified (S810). The first hub device 100-1 may generate (or update) the candidate list including the first hub device 100-1, the second hub device 100-2, and the third hub device 100-3 based on the connection response received from the second hub device 100-2 (S850). After the update, operations S851-1, S851-2, S852-1, and S852-2 may be performed.

According to various embodiments, the operation of updating the candidate list may be performed directly in the second hub device 100-2. The second hub device 100-2 may transmit the updated candidate list to the first hub device 100-1 and the third hub device 100-3.

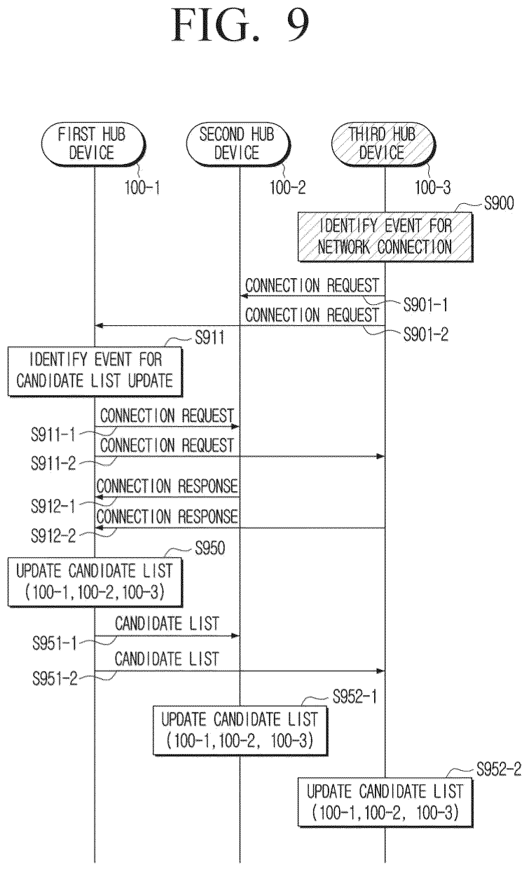

FIG. 9 is a diagram for describing an operation of updating a candidate list, according to an embodiment.

Operations S910, S911-1, S911-2, S912-1, S912-2, S950, S951-1, S951-2, S952-1, and S952-2 in FIG. 9 may correspond to S710, S711-1, S711-2, S712-1, S712-2, S750, S751-1, S751-2, S752-1, and S752-2 in FIG. 7. Redundant descriptions will be omitted.

The third hub device 100-3 may identify an event for network connection (S900). The event for network connection may include at least one of an event in which a power supply is connected and an event in which a user input for network connection is received. The event for network connection may be described as the network connection event of the third hub device 100-3.

When the event for network connection is identified, the third hub device 100-3 may broadcast a signal for connection (i.e., a connection request) to the AP network 10. The third hub device 100-3 may transmit the connection request to the second hub device 100-2 (S901-1). The third hub device 100-3 may transmit the connection request to the first hub device 100-1 (S901-2).

The first hub device 100-1 may receive the connection request from the third hub device 100-3. Upon receiving the connection signal from the third hub device 100-3, the first hub device 100-1 may identify that the event for updating the candidate list has been generated (S911).

Operations S911-1, S911-2, S912-1, S912-2, S950, S951-1, S951-2, S952-1, and S952-2 may be performed by the first hub device 100-1, the second hub device 100-2 or the third hub device 100-3.

According to various embodiments, the second hub device 100-2 may receive the network connection signal broadcast from the third hub device 100-3. Upon receiving a connection signal from the third hub device 100-3, the second hub device 100-2 may determine that the event for updating the candidate list has been identified. The second hub device 100-2 may receive the connection response to the third hub device 100-3 and transmit the connection response to the first hub device 100-1. The first hub device 100-1 may update the candidate list based on the connection response to the third hub device 100-3 that has been shared. The operations related to this are described in FIG. 8.

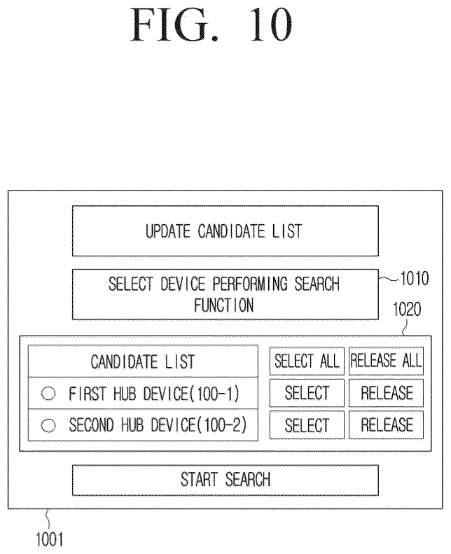

FIG. 10 is a diagram for describing a screen for a search function of a hub device, according to an embodiment.

Referring to FIG. 10, the first hub device 100-1 may provide a screen 1001 guiding the update of the candidate list. The screen 1001 may include at least one of a UI 1010 that guides selection of a device to perform a search function to update the candidate list, and a UI 1020 that indicates searchable devices included in the candidate list.

The first hub device 100-1 may receive the user input through the UI 1010. The first hub device 100-1 may determine a device to perform the search function based on the user input. The first hub device 100-1 may perform an operation of updating the candidate list based on the determined device.

When the user input for performing the search function is received through the first hub device 100-1, the first hub device 100-1 may broadcast the connection request for update. The operations related to this are described in FIG. 7.

When the user input for performing the search function is received through the second hub device 100-1, the first hub device 100-1 may transmit the control command for broadcasting the connection request for update to the second hub device 100-2. The second hub device 100-2 may receive the control command from the first hub device 100-1. The second hub device 100-2 may broadcast the connection request based on the control command. The operations related to this are described in FIG. 8.

According to various embodiments, the second hub device 100-2 may provide a screen 1001. The second hub device 100-2 may directly receive user input for selecting a device to perform a search function.

The second hub device 100-2 may update the candidate list based on the user input.

The second hub device 100-2 may perform the search function to update the candidate list. The second hub device 100-2 may broadcast the direct connection signal. The second hub device 100-2 may receive the connection response.

As an example, the second hub device 100-2 may transmit the connection response to the first hub device 100-1. The first hub device 100-1 may update the candidate list based on the connection response received from the second hub device 100-2. The first hub device 100-1 may transmit the updated candidate list to the second hub device 100-2 and the third hub device 100-3.

As an example, the second hub device 100-2 may directly update the candidate list based on the connection response. The second hub device 100-2 may transmit the updated candidate list to the first hub device 100-1 and the third hub device 100-3.

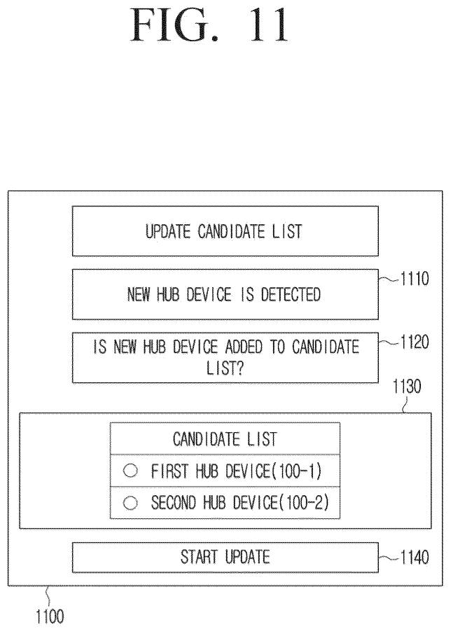

FIG. 11 is a diagram for describing a screen related to detection of a new hub device according to an embodiment.

Referring to FIG. 11, the first hub device 100-1 may provide a screen 1100 to notify the detection of a new hub device. The screen 1100 may include at least one of a UI 1110 indicating detection of a new hub device, a UI 1120 inquiring whether to add a new hub device to the candidate list, a UI 1130 indicating the candidate list, and a UI 1140 indicating a command for updating the candidate list.

When a user input is received through the UI 1140, the first hub device 100-1 may perform an operation of updating the candidate list.

According to various embodiments, the first hub device 100-1 may detect that the third hub device 100-3 may be included in the AP network 10. The first hub device 100-1 may broadcast a signal to notify that the third hub device 100-3 may operate as a new hub device. The first hub device 100-1 may perform an update operation to add the third hub device 100-3 to the candidate list. The first hub device 100-1 may transmit the updated candidate list to the second hub device 100-2 and the third hub device 100-3.

When the third hub device 100-3 is detected, the first hub device 100-1 may identify that the event for updating the candidate list has occurred. The operations related to this are described in FIG. 7.

According to various embodiments, the first hub device 100-1 may update the candidate list without providing the screen 1100.

According to various embodiments, the screen 1100 may be provided from the second hub device 100-2.

According to various embodiments, the second hub device 100-2 may detect that the third hub device 100-3 may be included in the AP network 10. The second hub device 100-2 may broadcast a signal to notify that the third hub device 100-3 may operate as a new hub device. The second hub device 100-2 may perform an update operation to add the third hub device 100-3 to the candidate list. The second hub device 100-2 may transmit the updated candidate list to the first hub device 100-1 and the third hub device 100-3.

When the third hub device 100-3 is detected, the second hub device 100-2 may identify that the event for updating the candidate list has occurred. The operations related to this are described in FIG. 8.

According to various embodiments, the second hub device 100-2 may update the candidate list without providing the screen 1100.

According to various embodiments, although the second hub device 100-2 detects the third hub device 100-3, the candidate list may be updated in the first hub device 100-1. The second hub device 100-2 may transmit the information (e.g., a connection request) about the third hub device 100-3 to the first hub device 100-1. The first hub device 100-1 may receive the information about the third hub device 100-3 from the second hub device 100-2 and update the candidate list based on the received information. The first hub device 100-1 may transmit the updated candidate list to the second hub device 100-2 and the third hub device 100-3.

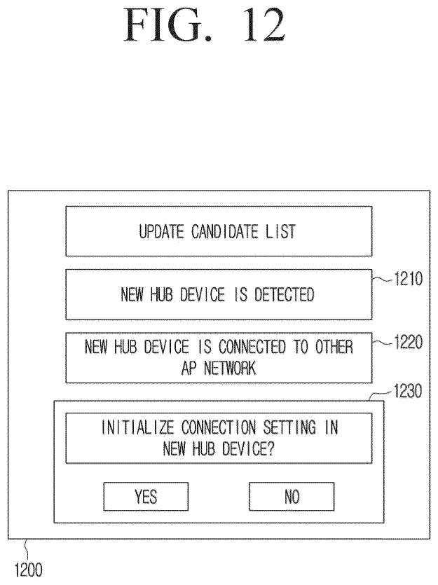

FIG. 12 is a diagram for describing a screen related to detection of a new hub device according to an embodiment.

Referring to FIG. 12, the first hub device 100-1 may provide a screen 1200 for initializing network connection settings in the third hub device 100-3. When the user input is received through the screen 1200, the first hub device 100-1 may initialize the network connection for the third hub device 100-3.

The screen 1200 may include at least one of a UI 1210 indicating that a new hub device has been detected, a UI 1220 indicating that the new hub device is connected to another AP network, and a UI 1230 for initializing network-related settings in the new hub device.

According to various embodiments, when a new hub device is detected, the first hub device 100-1 (or the second hub device 100-2) may confirm whether the new hub device is connected to the same AP network. It is assumed that the new hub device is the third hub device 100-3. The third hub device 100-3 may transmit the information about the AP network connected to (or connectable to) the first hub device 100-1.

The first hub device 100-1 may receive the information about the connectable AP networks from the third hub device 100-3. The first hub device 100-1 may receive the identification information of the AP network from the third hub device 100-3. The first hub device 100-1 may determine whether the AP network identification information transmitted from the third hub device 100-3 matches the identification information of the AP network stored in the first hub device 100-1.

When the identification information of the AP networks matches, the first hub device 100-1 may add the third hub device 100-3 to the candidate list.

When the identification information of the AP network does not match, the first hub device 100-1 may provide the screen 1200 for initializing network-related settings on the third hub device 100-3.

When the user input is received through the screen 1200, the first hub device 100-1 may initialize the network connection settings of the third hub device 100-3. The first hub device 100-1 may generate the control command for initializing network connection settings and transmit the generated control command to the third hub device 100-3.

The third hub device 100-3 may receive the control command from the first hub device 100-1. The third hub device 100-3 may initialize the network connection based on the received control command.

The first hub device 100-1 may initialize the network connection to the third hub device 100-3 and then add the third hub device 100-3 to the candidate list.

According to various embodiments, the first hub device 100-1 may perform the initialization operation for the third hub device 100-3 when the user input is received through the screen 1200.

According to various embodiments, the first hub device 100-1 may immediately perform the initialization operation for the third hub device 100-3 without providing the screen 1200.

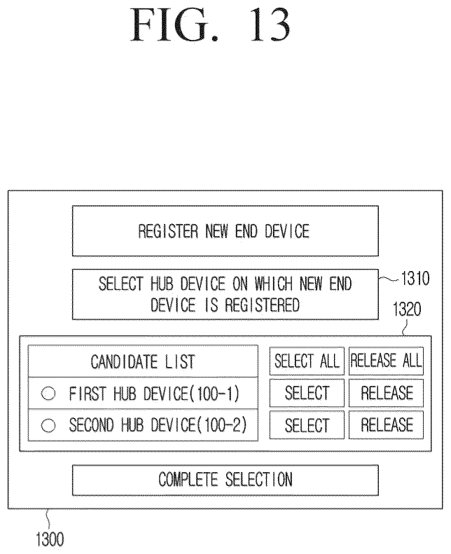

FIG. 13 is a diagram for describing a screen related to detection of a new end device according to an embodiment.

Referring to FIG. 13, the first hub device 100-1 may provide a screen 1300 for registering a new end device. The screen 1300 may include at least one of a UI 1310 that inquires about selecting a device to register as a new end device and a UI 1320 that displays a candidate list.

When a user input for registering a new end device is received through the screen 1300, the first hub device 100-1 may register a new end device based on the user input.

According to various embodiments, when the user input for registering a new end device is received, the first hub device 100-1 may immediately register the new end device.

The candidate list may include information about at least one hub device. The candidate list may include the end device information registered on at least one hub device. For example, the candidate list may include the identification information of the first hub device 100-1 and the identification information of the end devices 11 and 12 registered on the first hub device 100-1. The candidate list may include the identification information of the second hub device 100-2 and the identification information of the end device 13 registered on the second hub device 100-2. The candidate list may include the identification information of the third hub device 100-3 and the identification information of the end device 14 registered on the third hub device 100-3.

Once the registration of the new end device is completed, the first hub device 100-1 may update the candidate list. The candidate list may include information about new end devices.

According to various embodiments, the first hub device 100-1 may receive the user input for registering a new end device on the second hub device 100-2. The first hub device 100-1 may register a new end device on the second hub device 100-2 and generate (or update) the candidate list reflecting the registration results.

According to various embodiments, the registration process of a new end device may be performed through the second hub device 100-2. The second hub device 100-2 may receive the user input for registration of a new end device.

For example, when the user input for registering a new end device on the first hub device 100-1 is received, the second hub device 100-2 may transmit a control command to register the new end device on the first hub device 100-1 to the first hub device 100-1.

For example, when the user input for registering a new end device on the second hub device 100-2 is received, the second hub device 100-2 may register the new end device.

For example, after the registration, the update operation of the candidate list reflecting the registration result may be performed in the first hub device 100-1. The second hub device 100-2 may transmit the registration result to the first hub device 100-1. The first hub device 100-1 may update the candidate list based on the registration result. The first hub device 100-1 may transmit the updated candidate list to the second hub device 100-2 included in the candidate list.

For example, after the registration, the update operation of the candidate list reflecting the registration result may be performed in the second hub device 100-2. The second hub device 100-2 may update the new end device based on the registration result and transmit the updated candidate list to the first hub device 100-1 included in the candidate list.

According to various embodiments, one of the plurality of hub devices included in the AP network 10 may detect a new end device. A specific hub device that detects a new end device may update its candidate list. A specific hub device may determine which hub device the new end device is connected to. A specific hub device may update the candidate list based on the determination result. A specific hub device may transmit (or share) the updated candidate list to devices included in the candidate list.

FIG. 14 is a diagram for describing an operation of registering a hub device on a server according to an embodiment.

Referring to FIG. 14, the first hub device 100-1 may identify an event for server registration (S1410). The event for server registration may include an event in which the user input is received to register (or upload) the information about the hub device on the server. It is assumed that the candidate list includes the first hub device 100-1 and the second hub device 100-2.

When an event for server registration is identified in the first hub device 100-1, the first hub device 100-1 may determine the sub-hub device based on the candidate list (S1420). The first hub device 100-1 may determine itself (the first hub device 100-1) as the main hub device. The first hub device 100-1 may determine hub devices other than itself (the first hub device 100-1) among the plurality of devices included in the candidate list as sub-hub devices.

The first hub device 100-1 may transmit the activation request to the second hub device 100-2 identified as the sub-hub device (S1421). The activation request may include a signal to confirm whether it may operate as a sub-hub device. The second hub device 100-2 may receive the activation request from the first hub device 100-1. The second hub device 100-2 may generate an activation response indicating that it may perform the hub function in response to the activation request. The second hub device 100-2 may transmit the activation response to the first hub device 100-1 (S1422).

The first hub device 100-1 may receive the activation response from the second hub device 100-2. Upon receiving the activation response, the first hub device 100-1 may determine the first hub device 100-1 as the main hub device and the second hub device 100-2 as the sub-hub device (S1430).

The first hub device 100-1 may generate the connection list including the first hub device 100-1 and the second hub device 100-2 (S1450). The connection list may include the information about the hub device that may perform the hub function.

The connection list may include the information about the main hub device or the sub hub device. The connection list may include device identification information and device type information.

The type information may be information indicating whether it operates as a main hub device or a sub-hub device. When operating as the main hub device, the type information may indicate the first type (or main type). When operating as the sub-hub device, the type information may indicate a second type (or sub-type).

For example, the connection list may include the identification information of the first hub device 100-1 and the type information (main type) of the first hub device 100-1. The connection list may include the identification information of the second hub device 100-2 and the type information (subtype) of the second hub device 100-2.

According to various embodiments, when the hub device is unable to perform the hub function, the second hub device 100-2 may not generate the activation response. The second hub device 100-2 may transmit a notification that the activation is not possible to the first hub device 100-1. The first hub device 100-1 may generate the connection list that does not include the second hub device 100-2 based on the notification that the activation is not possible.

The first hub device 100-1 may transmit a request to register the first hub device 100-1 to the server 200 (S1451).

The server 200 may receive a registration request for the first hub device 100-1 from the first hub device 100-1. The server 200 may register the first hub device 100-1 based on the received registration request (S1452). The server 200 may transmit a registration completion notification to the first hub device 100-1 (S1453).

The candidate list may represent at least one hub device that may currently perform the hub function.

The connection list may represent the results of classifying hub devices included in the candidate list into main hub devices and sub-hub devices. The main hub device may communicate directly with the server 200. The sub hub device does not communicate directly with the server 200, but may communicate with the main hub device. The flow of the control signal related to the AP network 10 may be determined through the connection list.

According to various embodiments, the first hub device 100-1 may transmit the connection list to the second hub device 100-2 that has transmitted the activation response. The connection list may be shared with the device included in the connection list.

FIG. 15 is a diagram for describing an operation of registering a hub device on a server according to an embodiment.

Operations S1510, S1520, S1521, S1522, S1530, and S1550 of FIG. 15 may correspond to operations S1410, S1420, S1421, S1422, S1430, and S1450 of FIG. 14. Redundant descriptions will be omitted.

The first hub device 100-1 may transmit the connection list to the server 200 (S1551). The server 200 may receive the connection list from the first hub device 100-1 and perform the registration operation based on the received connection list. The server 200 may register the first hub device 100-1 as the main hub device and the second hub device 100-2 as the sub-hub device (S1552). The server 200 may transmit a registration completion notification to the first hub device 100-1 (S1553).

According to various embodiments, only the information for registration may be transmitted to the server 200 without generating the connection list. The first hub device 100-1 may transmit the information necessary for registration to the server 200. The first hub device 100-1 may transmit a request to register the first hub device 100-1 and the second hub device 100-2 to the server 200. The server 200 may register the first hub device 100-1 and the second hub device 100-2.

The first hub device 100-1 may transmit a request to the server 200 to register the first hub device 100-1 as the main hub device and the second hub device 100-2 as the sub-hub device. Based on the transmitted request, the server 200 may register the first hub device 100-1 as the main hub device and the second hub device 100-2 as the sub-hub device in the AP network 10.

When the second hub device 100-2 does not transmit the activation response, the first hub device 100-1 may transmit a request to register the first hub device 100-1 to the server 200. Because the second hub device 100-2 did not transmit the activation response, the server 200 may not perform the registration operation.

According to various embodiments, the registration event may be identified without the candidate list being generated. When the registration event is identified without the candidate list being generated, the first hub device 100-1 may acquire (or search) the device connected to the AP network 10. The first hub device 100-1 may store the information related to the AP network 10 in advance. It is assumed that the first hub device 100-1 has identified a registration event while storing information about the AP network 10 in advance. The information about the AP network 10 may include the device identification information that communicates with the AP network 10.

When the candidate list does not exist after the registration event is identified, the first hub device 100-1 may acquire the device identification information communicating with the AP network 10. The device identification information may be information previously stored in at least one of the first hub device 100-1 or the AP network 10. The first hub device 100-1 may acquire an additional target based on the device identification information communicating with the AP network 10.

The first hub device 100-1 may transmit a request to register the first hub device 100-1 and an additional target to the server 200. The first hub device 100-1 may transmit the identification information of the first hub device 100-1 and the identification information of the device communicating with the AP network 10 to the server 200. The first hub device 100-1 may transmit the information (e.g., type information) indicating that the first hub device 100-1 operates as the main hub device to the server 200.

When the registration event is identified while the candidate list has not been generated, the first hub device 100-1 may broadcast the registration request. The first hub device 100-1 may receive the registration response corresponding to the registration request. The first hub device 100-1 may transmit the request to the server 200 to register the hub device that has transmitted the registration response. The first hub device 100-1 may immediately request registration in the server 200 without generating the candidate list.

According to various embodiments, it is assumed that the event for registering the second hub device 100-2 has occurred. It is assumed that the event for registering the second hub device 100-2 has occurred in the server 200. The second hub device 100-2 may transmit the registration request to the server 200.

When the registration event occurs, the second hub device 100-2 may directly generate the connection list.

When the registration event occurs, the second hub device 100-2 may receive the connection list from another hub device.

The second hub device 100-2 may transmit the connection list to the second hub device 100-2. The server 200 may perform the registration process based on the connection list. When the connection list includes the first hub device 100-1 and the second hub device 100-2, the server 200 may register the first hub device 100-1 and the second hub device 100-2.

According to various embodiments, when the registration event is identified in the second hub device 100-2, the second hub device 100-2 may attempt to transmit the registration request to the server 200. When the second hub device 100-2 is unable to communicate with the server 200, the second hub device 100-2 may transmit the registration request to the server 200 using the first hub device 100-1. The second hub device 100-2 may transmit the control command for transmitting the registration request to the server 200 to the first hub device 100-1. The first hub device 100-1 may transmit the registration request to the server 200 based on the control command received from the second hub device 100-2. The connection list may be included in the registration request.

According to various embodiments, when the registration event is identified in the second hub device 100-2, the second hub device 100-2 may transmit the registration request for the second hub device 100-2 to the server 200. The second hub device 100-2 may transmit a request to the server 200 to register only the second hub device 100-2 without the first hub device 100-1.

According to various embodiments, when the registration event is identified, the first hub device 100-1 may identify that the event for updating the candidate list has occurred. The first hub device 100-1 may update the candidate list according to the registration event. The descriptions related to this are described in FIG. 7.

FIG. 16 is a diagram for describing an operation of transmitting a control command to an end device according to an embodiment.

Referring to FIG. 16, the server 200 may acquire the control command for the end device (S1610). The end device may refer to an IoT device that may not perform (or is not currently performing) the hub function. The descriptions related to this are described in FIG. 1. The server 200 may receive the control commands for the end device. For example, the server 200 may acquire the user command for controlling the end device from the user terminal device. It is assumed that the control command for the end device 13 in FIG. 1 is received.

The server 200 may acquire (or identify) the AP network 10 connected to the end device 13 based on the control command (S1620). The AP network 10 connected to the end device 13 may represent the AP network 10 including the second hub device 100-2 connected to the end device 13. The server 200 may determine which network the end device 13 for performing the control command belongs to. The server 200 may identify the end device 13 as the device belonging to the AP network 10 based on the control command.

The server 200 may identify the hub device corresponding to the AP network 10 based on pre-registered information (S1630). The server 200 may identify that the hub device corresponding to the AP network 10 is the first hub device 100-1 based on the pre-registered information. The pre-registered information may include the information that the main device of the AP network 10 is the first hub device 100-1. The server 200 may transmit the control command to the first hub device 100-1.

The first hub device 100-1 may receive the control command. The first hub device 100-1 may acquire the hub device corresponding to the end device 13 based on the received control command (S1640). The first hub device 100-1 may acquire (or identify) the hub device to which the end device 13 is connected (or registered) based on the pre-stored connection list. The first hub device 100-1 may identify that the end device 13 is connected to (or registered in) the second hub device 100-2 based on the connection list.

The first hub device 100-1 may transmit the control command to the second hub device 100-2 (S1641). The second hub device 100-2 may receive the control command from the first hub device 100-1. The second hub device 100-2 may transmit the control command to the end device 13 (S1650). The end device 13 may receive the control command from the second hub device 100-2. The end device 13 may perform the function corresponding to the control command.

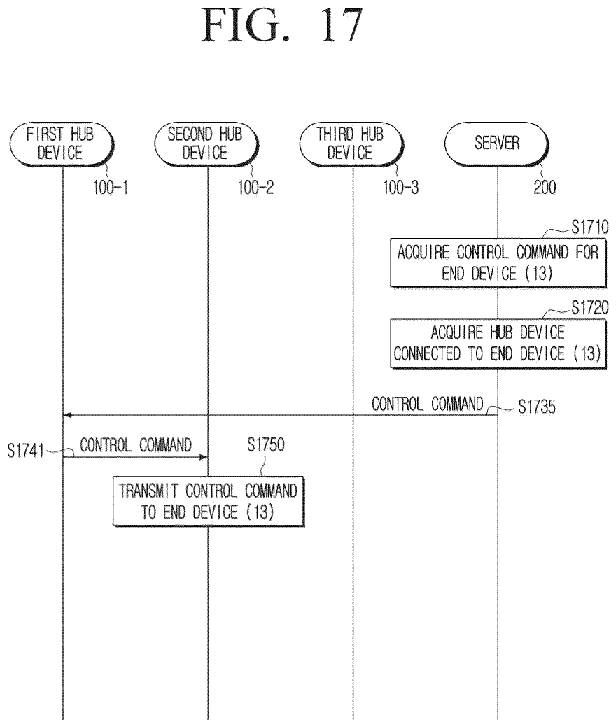

FIG. 17 is a diagram for describing an operation of transmitting a control command to an end device according to an embodiment.

Referring to FIG. 17, the server 200 may acquire the control command for the end device 13 (S1710). The description related to the end device and control command is described in FIG. 16. Redundant descriptions will be omitted. FIG. 17 assumes that the server 200 registers all devices activated in relation to the AP network 10. The descriptions related to this are described in FIG. 15.

The server 200 may acquire the hub device connected to the end device 13 based on the pre-registered information (S1720). It is assumed that the acquired hub device is the first hub device 100-1.

The server 200 may transmit the control command to the first hub device 100-

1 (S1735).

The first hub device 100-1 may identify the hub device to which the end device 13 included in the control command is connected based on the received control command. It is assumed that the identified hub device is the second hub device 100-2.

The first hub device 100-1 may immediately transmit the control command received from the server 200 to the second hub device 100-2 (S1741). The second hub device 100-2 may receive the control command from the first hub device 100-1. The second hub device 100-2 may transmit the control command to the end device 13 (S1750).

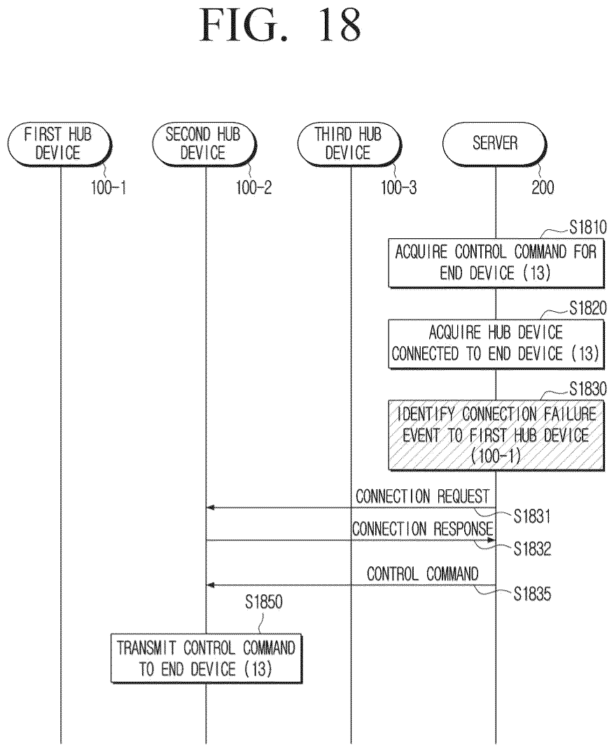

FIG. 18 is a diagram for describing an operation of transmitting a control command to an end device according to an embodiment.

Operations S1810 and S1820 of FIG. 18 may correspond to operations S1610 and S1620 of FIG. 16. Redundant descriptions will be omitted.

The server 200 may identify a connection failure event related to the first hub device 100-1 (S1830). The connection failure event may include at least one of an event in which a communication session is terminated, an event in which information may not be transmitted, an event in which a response regarding whether information has been received is not received, and an event in which a notification that communication is not possible. It is assumed that the communication session between the first hub device 100 and the server 200 is terminated.

The server 200 may request the connection to the second hub device 100-2 instead of the first hub device 100-1 based on the pre-registered information (S1831). This is because the second hub device 100-2 is registered as the sub-hub device 5 in the AP network 10 that includes the first hub device 100-1.

The second hub device 100-2 may receive the connection request from the server 200 and determine whether it is possible to establish a connection session with the server 200. When the connection is possible, the second hub device 100-2 may transmit the connection response to the server 200. The server 200 may receive the connection response from the second hub device 100-2. The server 200 may establish the communication session with the second hub device 100-2 based on the connection response.

After establishing the communication session, the server 200 may transmit the control command to the second hub device 100-2 (S1835). The second hub device 100-2 may identify the hub device on which the end device 13 is registered based on the control command. Because the second hub device 100-2 is the hub device on which the end device 13 is registered, the second hub device 100-2 may immediately transmit the control command to the end device 13 (S1850).

FIG. 19 is a diagram for describing a screen for selecting a registered device according to an embodiment.

Referring to FIG. 19, the first hub device 100-1 may provide a screen 1900 for selecting a device to be registered on the server 200. The screen 1900 may include at least one of a UI 1910 that guides selection of a device to be registered and a UI 1920 that displays a connection list.

When the user input for selecting a device to be registered is received through the screen 1900, the first hub device 100-1 may request the registration of the selected device from the server 200 based on the user input.

According to various embodiments, the first hub device 100-1 may request the registration of all the devices included in the connection list from the server 200. As an example, the first hub device 100-1 may receive the user input requesting the registration of all the devices. As an example, the first hub device 100-1 may request the registration of all the devices from the server 200 by transmitting all the connection lists to the server 200 without providing the screen 1900.

According to various embodiments, the first hub device 100-1 may receive the user input for selecting some devices of the plurality of devices included in the connection list. The first hub device 100-1 may request the second hub device 100-2 to register some devices selected based on the user input.

Only some of the devices selected by the user may be registered on the server 200.

According to various embodiments, the first hub device 100-1 may identify devices that may not be registered among some devices selected by the user. The device that may not be registered may include a device that may not be recognized by the server 200. The device that cannot be registered may include a device that cannot be recognized by the server 200. Even if the device that has requested the registration is identified as a device that cannot be registered, the first hub device 100-1 may not request the registration from the server 200.

According to various embodiments, the server 200 may receive the registration request for the plurality of devices from the first hub device 100-1. The server 200 may identify the device that cannot be registered among the plurality of devices for which the registration has been requested. The server 200 may register the remaining devices except for the device that may not be registered. The server 200 may transmit the registration result to the first hub device 100-1.

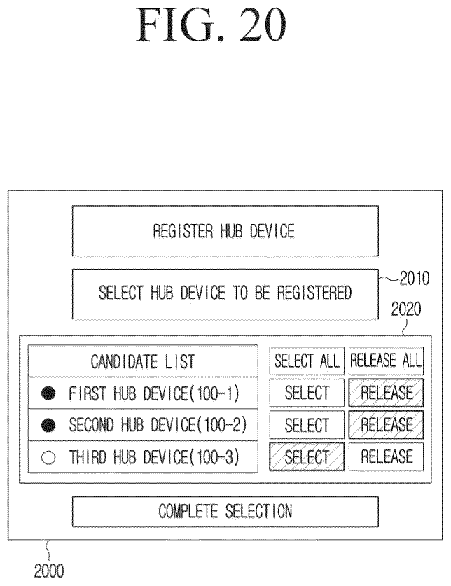

FIG. 20 is a diagram for describing a screen for selecting a registered device according to an embodiment.

Referring to FIG. 20, the first hub device 100-1 may provide a screen 2000 indicating the registration status of the hub device. The screen 2000 may include at least one of a UI 2010 that guides selection of a hub device to be registered and a UI 2020 that indicates the registration status of each hub device included in the candidate list.

The screen 2000 may include the information about the registration status of each hub device included in the AP network 10.

The first hub device 100-1 may receive a user input requesting registration for a specific hub device through the screen 2000. The first hub device 100-1 may receive a user input for requesting deregistering for a specific hub device through the screen 2000.

It is assumed that only some of the plurality of devices included in the candidate list are registered. When a user input for deregistration of the registered hub device is received, the first hub device 100-1 may transmit the deregistration request for the selected device to the server 200 based on the user input. When a user input for registration of an unregistered hub device is received, the first hub device 100-1 may transmit the registration request for the selected device to the server 200 based on the user input.

FIG. 21 is a diagram for describing an operation of updating a candidate list, according to an embodiment.

Operations S2110, S2111-1, S2111-2, S2112-1, S2150, S2151-1, and S2152-1 in FIG. 21 may correspond to operations S710, S711-1, S711-2, S712-1, S750, and S751-1 in FIG. 7. Redundant descriptions will be omitted.

It is assumed that the candidate list includes the first hub device 100-1, the second hub device 100-2, and the third hub device 100-3, and the third hub device 100-3 leaves the AP network 10 and is to be deleted from the candidate list.

The first hub device 100-1 may identify the event in which the third hub device 100-3 is not included in the AP network 10. The event in which the third hub device 100-3 is not included in the AP network 10 may indicate that the third hub device 100-3 is no longer connected to the AP network 10. As an example, the user may directly disconnect the third hub device 100-3. As an example, the power supply of the third hub device 100-3 may be turned off.

When the event in which the third hub device 100-3 is not included in the AP network 10 is identified, the first hub device 100-1 may identify that the event for updating the candidate list has occurred (S2110).

The first hub device 100-1 may transmit the connection request to the second hub device 100-2 based on the candidate list (S2111-1). The first hub device 100-1 may transmit the connection request to the third hub device 100-3 based on the candidate list (S2111-2).

The second hub device 100-2 may transmit the connection response to the first hub device 100-1. Because the connection has been terminated, the third hub device 100-3 cannot transmit the connection response to the first hub device 100-1.

Because the connection response has not been received from the third hub device 100-3, the first hub device 100-1 may delete the third hub device 100-3 from the candidate list.

The first hub device 100-1 may generate (or update) the candidate list including the first hub device 100-1 and the second hub device 100-2.

The first hub device 100-1 may transmit the candidate list to the second hub device 100-2 (S2151-1). The second hub device 100-2 may store the candidate list (S2152-1).

According to various embodiments, the second hub device 100-2 may identify the event in which the third hub device 100-3 is not included in the AP network 10. The second hub device 100-2 may directly update the candidate list. Although the operation disclosed in FIG. 21 is described as being performed by the first hub device 100-1, the operation performed by the first hub device 100-1 may be performed by the second hub device 100-2. The second hub device 100-2 may generate (or update) the candidate list from which the third hub device 100-3 is excluded. The second hub device 100-2 may transmit the updated candidate list to the first hub device 100-1.

According to various embodiments, the second hub device 100-2 may identify the event in which the third hub device 100-3 is not included in the AP network 10. The second hub device 100-2 may transmit a notification indicating the occurrence of the event to the first hub device 100-1. When the event occurrence notification is received from the second hub device 100-2, the first hub device 100-1 may identify that the event for updating the candidate list has occurred.

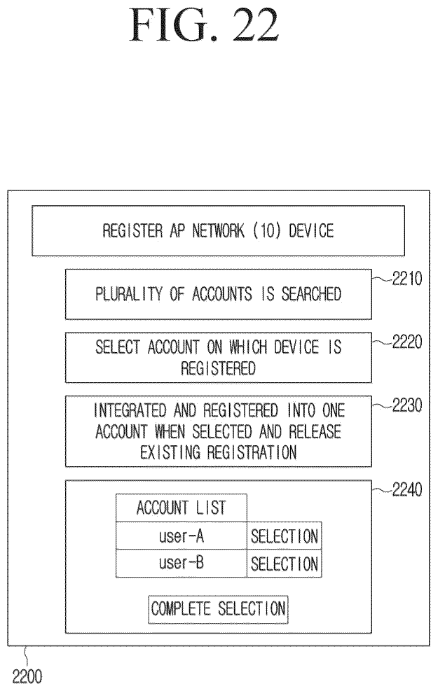

FIG. 22 is a diagram for describing a screen indicating a plurality of accounts according to an embodiment.

Referring to FIG. 22, the first hub device 100-1 may provide an account-related screen 2200. The screen 2200 may include at least one of a UI 2210 indicating the existence of a plurality of accounts, a UI 2220 guiding selection of a plurality of accounts, a UI 2230 providing information related to account selection, and a UI 2240 indicating a list related to a plurality of accounts.

A plurality of accounts may exist for a plurality of hub devices included in the AP network 10. Each account may include a user account used on the server 200. The server 200 may control devices included in the AP network 10 based on accounts.

For example, it is assumed that the AP network 10 includes the first hub device 100-1 and the second hub device 100-2. It is assumed that the first hub device 100-1 is controlled by a first account (user-A), and the second hub device 100-2 is controlled by a second account (user-B). When registering the first hub device 100-1 and the second hub device 100-2 on the server 200, an account conflict event may occur because the first and second hub devices 100-1 and 100-2 are controlled by different user accounts.

The account conflict event may include the event in which a plurality of accounts are identified. When the account conflict event occurs, the first hub device 100-1 may provide a screen 2200 to guide the user's selection. The first hub device 100-1 may receive a user input for selecting one account from among a plurality of accounts through the screen 2200. The first hub device 100-1 may request the registration of the first hub device 100-1 and/or the second hub device 100-2 from the server 200 based on the user input.

According to various embodiments, the first hub device 100-1 may automatically select an account without providing the screen 2200.

As an example, the first hub device 100-1 may select one of a plurality of accounts based on a predetermined priority. The predetermined priority may be the account used in the main hub device. The first hub device 100-1 may select an account connected to (or used) by a hub device classified as the main hub device from among a plurality of accounts.

As an example, the first hub device 100-1 may select one of the plurality of accounts based on account history. The first hub device 100-1 may pre-store the account history. The account history may include the number of times the account has accessed the server 200. The first hub device 100-1 may compare the number of times it accesses the server 200 for each account. The first hub device 100-1 may select the account that has accessed the server 200 the most among the plurality of accounts.

According to various embodiments, there may be a plurality of accounts for controlling the AP network 10. The first hub device 100-1 may request registration from the server 200 using a plurality of accounts. The first hub device 100-1 may select one representative account from among the plurality of accounts and request registration with the selected representative account from the server 200. Once the registration as the representative account is completed, the server 200 may grant sharing authority to the remaining accounts that are not the representative account among the plurality of accounts. The control authority of the representative account may be granted to the remaining accounts. The server 200 may register all the plurality of accounts.

According to various embodiments, the first hub device 100-1 may simultaneously transmit the plurality of accounts for managing the registration requests to the server 200. The server 200 may perform the registration process requested by the first hub device 100-1 for each of the plurality of accounts. The first hub device 100-1 may transmit an account list including a plurality of accounts and identification information (or connection list) indicating registration target devices to the server 200. The server 200 may register (or connect) the registration target device to all devices included in the received account list.

For example, it is assumed that the first hub device 100-1 is controlled by a first account (user-A), and the second hub device 100-2 is controlled by a second account (user-B). When registering the first hub device 100-1 and the second hub device 100-2 on the server 200, an account conflict event may not occur. The server 200 may register the first hub device 100-1 and the second hub device 100-2 in the first account (user-A), and the first hub device 100-1 and the second hub device 100-2 in the second account (user-B).

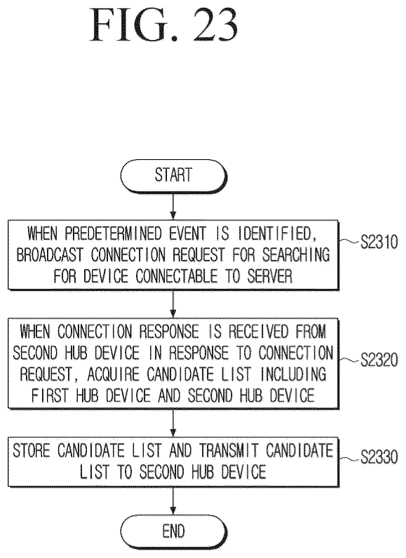

FIG. 23 is a diagram for describing a control method of a hub device, according to an embodiment.

Referring to FIG. 23, the control method of the first hub device may include broadcasting a connection request to search for devices that can connect to the server when a predetermined event is identified (S2310), acquiring a candidate list including the first hub device and the second hub device when a connection response is received from the second hub device in response to the connection request (S2320), and storing the candidate list and transmitting the candidate list to the second hub device (S2330).

The first hub device includes a first communication module and a second communication module, and the control method may further include connecting to a server through the first communication module and connecting to the second hub device through the second communication module.

In the operation of acquiring the candidate list (S2020), when the connection response is received using the predetermined communication method, the candidate list including the first hub device and the second hub device is acquired, and the predetermined communication method may be Bluetooth Low Energy (BLE).

In the operation of acquiring the candidate list (S2020), the candidate list including the identification information of the second hub device may be acquired based on the connection response.

The connection request is a first connection request and the candidate list is a first candidate list, and the control method may further include broadcasting a second connection request when an event is identified in which a third hub device is detected, acquiring a second candidate list including the first hub device, the second hub device, and the third hub device when a second connection response is received from the third hub device in response to the second connection request, updating the first candidate list to the second candidate list, and transmitting the second candidate list to the second hub device and the third hub device.

The control method may further include broadcasting a third connection request when an event is identified in which a third hub device is not detected, acquiring a third candidate list including the first hub device and the second hub device when a response corresponding to the third connection request is not received from the third hub device within a predetermined time, updating the second candidate list to the third candidate list, and transmitting the third candidate list to the second hub device.

The control method may further include transmitting an activation request to a second hub device included in the candidate list when a user input for registration is received, generating a connection list including the first hub device and the second hub device when an activation response is received from the second hub device in response to the activation request, and transmitting the connection list to the server.

The control method may further include transmitting the control command to the second hub device when the control command (or a control command related to the end device) for controlling the end device connected to the second hub device is received from the server

The control method may further include transmitting the control information to the server when the control information (or control information related to the end device) related to the end device connected to the second hub device is received from the second hub device.

The control method may further include displaying a guide screen including a connection list, and transmitting the registration request of the first hub device to the sever when the user input (or a user input corresponding to registration) for registering the first hub device is received through the guide screen.

The above-described methods according to various embodiments may be implemented in a form of a memory storing instructions that may be executed by an electronic device (or hub device).

In addition, the above-described methods according to various embodiments may be implemented only by hardware including one or more processors controlled by software.

Further, various embodiments of the disclosure described above may also be performed through an embedded server included in the electronic device or an external server of at least one of the electronic device or the display device.

According to an embodiment of the disclosure, various embodiments described above may be implemented by instructions stored in a machine-readable storage medium (for example, a computer-readable storage medium). A machine is a device capable of calling a stored instruction from a storage medium and operating according to the called instruction, and may include the electronic device of the disclosed embodiments. In the case in which a command is executed by the processor, the processor may directly perform a function corresponding to the command or other components may perform the function corresponding to the command under a control of the processor. The command may include codes generated or executed by a compiler or an interpreter. The machine-readable storage medium may be provided in a form of a non-transitory storage medium. Here, the term “non-transitory” indicates that the storage medium is tangible without including a signal, and does not distinguish whether data are semi-permanently or temporarily stored in the storage medium.

In addition, according to an embodiment of the disclosure, instructions to control a computer to perform the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

In addition, each of components (for example, modules) according to various embodiments described above may include a single entity or a plurality of entities, and some of the corresponding sub-components described above may be omitted or other sub-components may be further included in the diverse embodiments. Alternatively or additionally, some constituent elements (for example, a module or a program) may be integrated into a single entity to perform the same or similar functions performed by each corresponding constituent element prior to the integration. Operations performed by the modules, the programs, or the other components according to various embodiments may be executed in a sequential manner, a parallel manner, an iterative manner, or a heuristic manner, at least some of the operations may be performed in a different order or be omitted, or other operations may be added.

While aspects of embodiments have been particularly shown and described, it will be understood that various changes in form and details may be made therein without departing from the spirit and scope of the following claims.

What is claimed is:

1. A first hub device, comprising:
a memory storing instructions;
a communication interface;
at least one processor; and
wherein the instructions that, when executed by the at least one processor, cause the first hub device to:
broadcast, through the communication interface, a connection request to search for a device configured to connect to a server, based on a predetermined event being identified; and
transmit, through the communication interface, a candidate list indicating the first hub device and a second hub device to the second hub device based on a response corresponding to the connection request being received from the second hub device.

2. The first hub device as claimed in claim 1, wherein the communication interface comprises a first communication module and a second communication module, and
wherein the instructions, when executed by the at least one processor, cause the first hub device to:
connect to the server through the first communication module; and
connect to the second hub device through the second communication module.

3. The first hub device as claimed in claim 1, wherein the instructions, when executed by the at least one processor, cause the first hub device to acquire the candidate list indicating the first hub device and the second hub device based on the response being received through Bluetooth low energy (BLE) communication.

4. The first hub device as claimed in claim 1, wherein the instructions, when executed by the at least one processor, cause the first hub device to acquire the candidate list including identification information indicating the second hub device based on the response.

5. The first hub device as claimed in claim 1, wherein the connection request is a first connection request,
wherein the response is a first connection response,
wherein the candidate list is a first candidate list, and
wherein the instructions, when executed by the at least one processor, cause the first hub device to:
broadcast, through the communication interface, a second connection request based on a third hub device being identified;
acquire a second candidate list indicating the first hub device, the second hub device, and the third hub device based on a second response corresponding to the second connection request being received from the third hub device;
update the first candidate list to the second candidate list; and
transmit the second candidate list to the second hub device and the third hub device through the communication interface.

6. The first hub device as claimed in claim 5, wherein the instructions, when executed by the at least one processor, cause the first hub device to:
broadcast, through the communication interface, a third connection request based on the third hub device not being detected;
acquire a third candidate list indicating the first hub device and the second hub device based on a response corresponding to the third connection request not being received from the third hub device within a predetermined time;
update the second candidate list to the third candidate list; and
transmit the third candidate list to the second hub device through the communication interface.

7. The first hub device as claimed in claim 1, wherein the instructions, when executed by the at least one processor, cause the first hub device to:
transmit an activation request to the second hub device through the communication interface based on a first user input for registration being received;
generate a connection list indicating the first hub device and the second hub device based on an activation response corresponding to the activation request being received from the second hub device; and
transmit the connection list to the server through the communication interface.

8. The first hub device as claimed in claim 7, wherein the instructions, when executed by the at least one processor, cause the first hub device to:
receive, through the communication interface, a control command from the server related to an end device connected to the second hub device; and
transmit the control command to the second hub device through the communication interface.

9. The first hub device as claimed in claim 7, wherein the instructions, when executed by the at least one processor, cause the first hub device to transmit control information to the server through the communication interface when a control command related to an end device connected to the second hub device is received from the second hub device.

10. The first hub device as claimed in claim 7, further comprising a display,
wherein the instructions, when executed by the at least one processor, cause the first hub device to:
control the display to output a guide screen including the connection list; and
transmit a registration request for the first hub device to the server through the communication interface based on a second user input corresponding to the registration of the first hub device being received through the guide screen.

11. A control method of a first hub device, comprising:
broadcasting a connection request to search for a device configured to connect to a server based on a predetermined event being identified; and
transmitting a candidate list indicating the first hub device and a second hub device to the second hub device based on a response corresponding to the connection request being received from the second hub device.

12. The control method as claimed in claim 11, wherein the first hub device includes a first communication module and a second communication module, and
wherein the control method further comprises:
connecting the first hub device to the server through the first communication module; and
connecting the first hub device to the second hub device through the second communication module.

13. The control method as claimed in claim 11, further comprising acquiring the candidate list indicating the first hub device and the second hub device based on the response being received through Bluetooth low energy (BLE) communication.

14. The control method as claimed in claim 11, further comprising acquiring the candidate list including identification information indicating the second hub device based on the response.

15. The control method as claimed in claim 11, wherein the connection request is a first connection request,
wherein the response is a first connection response,
wherein the candidate list is a first candidate list, and
wherein the control method further comprises:
broadcasting a second connection request based on a third hub device being identified;
acquiring a second candidate list indicating the first hub device, the second hub device, and the third hub device based on a second response corresponding to the second connection request being received from the third hub device;
updating the first candidate list to the second candidate list; and
transmitting the second candidate list to the second hub device and the third hub device.

16. A non-transitory computer-readable medium storing computer instructions for a first hub device to perform an operation, the operation comprising:
broadcasting a connection request to search for a device configured to connect to a server based on a predetermined event being identified; and
transmitting a candidate list indicating the first hub device and a second hub device to the second hub device based on a response corresponding to the connection request being received from the second hub device.

17. The non-transitory computer-readable medium as claimed in claim 16, wherein the first hub device includes a first communication module and a second communication module,
wherein the first hub device is connected to the server through the first communication module, and
wherein the first hub device is connected to the second hub device through the second communication module.

18. The non-transitory computer-readable medium as claimed in claim 16, wherein the operation further comprises acquiring the candidate list indicating the first hub device and the second hub device based on the response being received through Bluetooth low energy (BLE) communication.

19. The non-transitory computer-readable medium as claimed in claim 16, the operation further comprises acquiring the candidate list including identification information indicating the second hub device based on the response.

20. The non-transitory computer-readable medium as claimed in claim 16, wherein the connection request is a first connection request,
wherein the response is a first connection response,
wherein the candidate list is a first candidate list, and
wherein the operation further comprises:
broadcasting a second connection request based on a third hub device being identified;
acquiring a second candidate list indicating the first hub device, the second hub device, and the third hub device based on a second response corresponding to the second connection request being received from the third hub device;
updating the first candidate list to the second candidate list; and
transmitting the second candidate list to the second hub device and the third hub device.
